(19) United States
(12) Patent Application Publication
(10) Pub. No.: US 2025/0192193 A1
(43) Pub. Date: Jun. 12, 2025

(54) METHOD OF MANUFACTURING A COMPONENT FOR AN ELECTROCHEMICAL SYSTEM AND COMPONENT FOR AN ELECTROCHEMICAL SYSTEM

(71) Applicant: Reinz-Dichtungs-GmbH, Neu-Ulm (DE)

(72) Inventors: Lisa JERG, Krumbach (DE); Bernd GAUGLER, Laichingen (DE); Stephan WENZEL, Tomerdingen (DE)

(21) Appl. No.: 18/970,649

(22) Filed: Dec. 5, 2024

(30) Foreign Application Priority Data
Dec. 6, 2023 (DE) 10 2023 134 144.8

(51) Int. Cl. H01M 8/0241; C25B 13/05; H01M 8/0232; H01M 8/0273; H01M 8/0282

(52) U.S. Cl. CPC H01M 8/0241; C25B 13/05; H01M 8/0232; H01M 8/0273; H01M 8/0282

(57) ABSTRACT

The present disclosure relates to a method of manufacturing a component for an electrochemical system. The method comprises steps in which at least one metallic layer with at least one sealing bead formed therein is provided, each of at least two first surface regions of the at least one sealing bead are subjected to at least one laser treatment, and each of at least one second surface region of the at least one sealing bead, which is arranged between the at least two first surface regions and directly adjoins the at least two first surface regions, is provided with at least one elastomeric sealing element. In addition, the present disclosure also relates to a component for an electrochemical system and an electrochemical system comprising the component.

### CROSS REFERENCE TO RELATED APPLICATION

This application claims priority to German Patent Application No. 10 2023 134 144.8, entitled “METHOD OF MANUFACTURING A COMPONENT FOR AN ELECTROCHEMICAL SYSTEM AND COMPONENT FOR AN ELECTROCHEMICAL SYSTEM”, filed Dec. 6, 2023. The entire contents of the above-identified application is hereby incorporated by reference for all purposes.

### TECHNICAL FIELD

The present disclosure relates to a method of manufacturing a component for an electrochemical system. The method comprises steps in which at least one metallic layer with at least one sealing bead formed therein is provided, each of at least two first surface regions of the at least one sealing bead are subjected to at least one laser treatment, and each of at least one second surface region of the at least one sealing bead, which is arranged between the at least two first surface regions and directly adjoins the at least two first surface regions, is provided with at least one elastomeric sealing element. In addition, the present disclosure also relates to a component for an electrochemical system and an electrochemical system comprising the component.

### BACKGROUND AND SUMMARY

Well-known electrochemical systems include fuel cell systems, flow batteries or electrochemical compressor systems and electrolyzers. Known electrolyzers are configured, for example, in such a way that hydrogen and oxygen are generated from water by applying a potential and at least the hydrogen is present in compressed form. In addition, electrochemical compressor systems such as electrochemical hydrogen compressors are also known, to which gaseous molecular hydrogen is fed and in which it is electrochemically compressed by applying a potential. In addition, known electrochemical systems include electrochemical separator systems in which, for example, hydrogen is extracted from one reaction system and enriched in another part of the electrochemical system.

Also known are electrochemical systems comprising a stack of electrochemical cells, each separated from one another by bipolar plates. Such bipolar plates may serve for example for indirectly electrically contacting the electrodes of the individual electrochemical cells (for example fuel cells) and/or for indirectly electrically connecting adjacent cells (series connection of the cells). The bipolar plates may also have a channel structure or may form a channel structure, which is configured to supply the cells with one or more media and/or to remove reaction products. The media may be fuels (for example hydrogen or methanol), reaction gases (for example air or oxygen) or coolants. Such a channel structure is usually located in an electrochemically active region (flow field) and in the distribution and collection areas leading to and from it. Furthermore, the bipolar plates may be configured to transmit the waste heat that arises when converting electrical and/or chemical energy in the electrochemical cell, and also to seal the various media channels, including the cooling channels, with respect to one another and/or with respect to the external environment. By way of example, the bipolar plates may have openings, through which the media to be fed and/or the reaction products can be routed towards or away from the electrochemical cells arranged between adjacent bipolar plates of the stack.

The electrochemical cells may for example each comprise one or more membrane electrode assemblies (MEAs). The MEAs may have one or more electrically conductive gas diffusion layers, which are usually oriented towards the bipolar plates and are configured for example as an electrically conductive fleece, in particular as a metal or carbon fleece. The membrane electrode assemblies usually have a frame-like seal at their outer edge, said seal being formed in particular of polymer-based material, preferably of polymer-based films.

The seal between the bipolar plates and the MEA is usually made outside the electrochemically active region and usually comprises at least one port seal as well as a perimetrical seal. The bipolar plates are usually composed of two separator plates, each of which adjoins a membrane electrode assembly. The separator plates can have seals for sealing against the membrane electrode unit, in particular against the frame-shaped seal of the membrane electrode unit; if the separator plates are configured as metallic plates, these seals can be molded directly into the separator plates as sealing beads, for example by embossing, deep drawing or hydroforming. Alternatively, it is also possible that the sealing beads are not molded into the separator plates or the bipolar plate, but into a sealing frame that surrounds the separator plate or bipolar plate or is arranged on it in the shape of a frame.

To improve micro-sealing, such sealing beads usually have polymer-based sealing coatings, in particular elastomer sealing elements, on at least one side. Examples thereof are mentioned in DE 10 2018 101 316 A1. To apply these elastomeric sealing elements, an elastomer-forming component (or an elastomer precursor) can be applied to the sealing bead or sealing beads as a component of or in an apolar liquid coating material. However, the process window for correctly setting the optimum parameters for the optimum viscosity of the coating material and the coating parameters for the achievable wet film thickness is very narrow. The process is therefore technically very demanding. If coating material runs from the bead roof onto the bead flanks, this leads to losses in the final height of the elastomeric sealing element. This results in higher leakage rates or can cause that the affected bipolar plate is classified defective.

Based on this, it is thus the task of the present disclosure to provide a method for manufacturing a component suitable for an electrochemical system comprising at least one metallic layer with at least one sealing bead molded therein, in which a coating of the at least one sealing bead can be carried out with increased accuracy, and to provide a component suitable for an electrochemical system comprising at least one metallic layer with at least one sealing bead molded therein, which can be manufactured in such a way that coating of the at least one sealing bead can be carried out with increased accuracy.

This problem is at least partially solved by a method, a component for an electrochemical system, and an electrochemical system as described herein.

According to the present disclosure, a method for producing a component for an electrochemical system is thus disclosed, in which
at least one metallic layer with at least one sealing bead formed therein is provided,
each of at least two first surface regions of the at least one sealing bead are subjected to at least one laser treatment, in which the at least two first surface regions are irradiated by means of a pulsed laser with laser pulses which have a pulse duration of less than 1 ns, wherein the at least one laser treatment produces surface structurings (that is, each laser treatment produces a surface structuring) on the at least two first surface regions, wherein the surface structurings comprise periodic structures that comprise alternately arranged, substantially strip-shaped protrusions and depressions, as well as nanostructures in the form of substantially dot-shaped protrusions that are arranged (at least) on the substantially strip-shaped protrusions, and
each of at least one second surface region of the at least one sealing bead, which is arranged between the at least two first surface regions and directly adjoins the at least two first surface regions, is provided with at least one elastomeric sealing element, wherein at least one (apolar) liquid coating material comprising at least one component forming at least one elastomer (or at least one elastomer precursor) is applied to the at least one second surface region.

With the method according to the present disclosure, it is possible to provide a desired region of the at least one sealing bead of the metallic layer with an elastomeric sealing element in a precise manner. For this purpose, on at least two surface regions (i.e. the at least two first surface regions of the at least one sealing bead) that directly adjoin the region to be coated (i.e. the at least one second surface region of the at least one sealing bead), hydrophilic, optionally superhydrophilic, surface structuring is ultimately produced on at least two surface regions (that is, a hydrophobic, optionally superhydrophobic surface structuring is produced on each surface region), wherein the provision with the at least one elastomeric sealing element is finally effected by applying at least one apolar liquid coating material comprising at least one elastomer. Since the hydrophilic surface structurings have a repellent effect on the apolar liquid coating material, the carrier liquid applied to the region to be coated stops at the edge of the region to be coated (immediately adjacent to the at least two first surface regions) and does not flow over the at least two surface regions with the surface structurings. The first two surface regions, i.e. the areas with surface structuring, therefore remain free of the apolar liquid coating material and thus also free of the coating. The surface structuring thus acts as a kind of flow stopper for the at least one apolar liquid coating material comprising the at least one elastomer, so that the elastomeric sealing element obtained is ultimately arranged only on the region to be coated, i.e. the at least one second surface region. The surface structurings can thus be created on regions that at least partially delimit the region to be coated, so that when the coating material is subsequently applied in the region to be coated, the coating material remains in the region to be coated and does not flow over the regions with the surface structurings into regions that are not to be coated. This ultimately enables a very precise application of the coating material and thus also a coating of the at least one sealing bead with increased accuracy, as it can be achieved that the coating material actually only reaches that region of the respective sealing bead which is to be coated and thus only this region is coated.

In particular, if the regions with the surface structures are arranged accordingly on the at least one sealing bead, the liquid coating material can be prevented from flowing from the bead roof onto the bead flanks, even if, for example, the liquid coating material has a relatively low viscosity and thus a relatively high tendency to flow. Accordingly, losses in the final height of the elastomer sealing element and the resulting higher leakage rates as well as rejects of components that are therefore not sufficiently sealed can be prevented.

In addition, the method according to the present disclosure simplifies the coating process when applying the liquid coating material, since, for example, the viscosity and the wet film thickness of the applied liquid coating material no longer have to be adjusted so precisely in order to reduce the risk of the liquid coating material flowing into a region that is not to be coated.

The position of the at least two first surface regions (and thus the position of the surface structuring) is variable and can optionally also be applied in a radius at the transition from the bead roof to one of the two bead flanks. This allows the maximum available width of the bead roof surface to be utilized and thus ensures the maximum possible sealing width of the elastomer sealing element.

Furthermore, the process according to the present disclosure can also be used to produce particularly thick elastomeric sealing elements, for example with a maximum thickness of at least 20 μm, optionally in the case of foamed material at least 50 μm, even with low-viscosity coating materials, since the surface structuring means that a larger quantity of liquid coating material can be applied to the region to be coated without some of the coating material flowing over the regions with the surface structuring. Consequently, a higher wet film thickness, and thus also a higher dry film thickness, can be achieved than in the prior art.

The special surface structurings also enable topographical configuring of the elastomer sealing element, and thus the sealing element and sealing bead system, without changing the height of the (metallic) sealing bead. This enables new system design approaches. Furthermore, by using the surface structures, it is possible to change the edge geometry of the elastomer sealing element in relation to the bead roof or the bead flanks. This can result in a significantly steeper transition from the bead roof to the upper edge of the coating material and thus a more even coating thickness of the sealing element and therefore improved contact with the next component, e.g. the edge reinforcement of the MEA.

The hydrophilic surface structures on the at least two first surface regions are produced by laser treatment. In the context of the present disclosure, it was surprisingly found that special surface structurings can be obtained that have hydrophilic, optionally superhydrophilic, properties, by laser treatment on the at least two first surface regions of the beads of the metallic plate. The special surface structurings obtained by the laser treatment have periodic structures and nanostructures arranged on the periodic structures, wherein the periodic structures comprise alternately arranged substantially strip-shaped protrusions and depressions, and wherein the nanostructures are formed in the form of substantially dot-shaped protrusions and are arranged (at least) on the substantially strip-shaped protrusions. The surface structurings produced by the laser treatment have hydrophilic, optionally superhydrophilic, properties and thus act as a kind of flow stopper for the at least one apolar liquid coating material comprising the at least one elastomer, so that the coating material applied to the at least one second surface region stops at the edge (immediately adjacent to the at least two first surface regions) of the at least one second surface region and does not flow onto or over the at least two first surface regions. This ultimately results in increased accuracy of the coating, as the surface structuring can prevent coating material from reaching regions that are not to be coated.

In step a) of the method according to the present disclosure, at least one metallic layer is first provided. The at least one metallic layer has at least one sealing bead molded into the at least one metallic layer.

The at least one metallic layer can, for example, be at least one metallic plate or at least one metallic frame. Optionally, the at least one metallic plate comprises two metallic plates. The two metallic plates can be separator plates, e.g. separator plates of a bipolar plate. The two metal plates can be connected to each other, e.g. welded together, or not connected to one another.

In step b) of the method according to the present disclosure, at least two first surface regions of the at least one sealing bead are each subjected to at least one laser treatment. In the laser treatment, the at least two first surface regions are irradiated with laser pulses by means of a pulsed laser, the laser pulses having a pulse duration of less than 1 ns. The laser pulses can also be referred to as ultrashort laser pulses. Accordingly, an ultrashort pulse laser (USP laser) can be used as the laser.

The at least one laser treatment produces surface structuring on the at least two first surface regions (that is, a surface structuring is produced on each of the at least two first surface regions). The at least two first surface regions are thus surface-structured surface regions after the at least one laser treatment. The surface structurings have periodic structures and nanostructures. The periodic structures extend over the entire surface-structured surface regions, i.e. over the entire at least two first surface regions.

The periodic structures are structures that are arranged periodically in relation to each other in at least one spatial direction. According to some embodiments, the periodic structures can be arranged parallel to one another, at least in sections. The alignment may exist over relatively large or relatively small regions. Different regions having parallel structures, but with a different orientation compared to another region, can also be adjacent to each other. This means that the shape of the periodic structures on the surface is repeated in at least one spatial direction. Periodic structures can generally be characterized by a spatial period. A spatial period typically refers to the maximum distance between two neighboring structures of the same or similar shape, e.g. two of the substantially strip-shaped protrusions or two of the substantially strip-shaped depressions. Due to the manufacturing process, the structures are generally not completely identical to each other. Rather, the period may be subject to fluctuations along the surface. An average spatial period of the periodic structures can optionally be less than 10 μm, optionally at most 2 μm. It is also possible that the spatial period of the periodic structures is in any case less than 10 μm, optionally at most 2 μm. For example, the periodic structures can have a period in a spatial direction x (parallel to the main extension plane of the surface) of less than 10 μm, optionally of at least 0.3 μm and/or at most 2 μm.

The periodic structures comprise alternately arranged substantially strip-shaped protrusions and depressions, i.e. the periodic structures comprise substantially strip-shaped protrusions and substantially strip-shaped depressions, wherein these protrusions and depressions are arranged alternately, i.e. the depressions each extend between the (or two of the) protrusions and are bounded and/or formed by them. Substantially strip-shaped can be understood here (and in principle in the context of the entire present disclosure) to mean that a (maximum) length of the respective protrusion or depression is significantly greater, optionally at least 4 times greater, optionally at least 5 times greater, than a (maximum) width of the respective protrusion or depression. The substantially strip-shaped protrusions and/or depressions can each have an (essentially) linear course and/or a non-linear course, for example a single or multiple curved (e.g. wavy) course, at least in sections. It is also possible, for example, for the width of the substantially strip-shaped protrusions and/or the width of the substantially strip-shaped depressions to vary along their course. For example, the substantially strip-shaped protrusions and/or depressions can also be partially branched.

In the context of the entire present disclosure, it applies that the (maximum) width and/or (maximum) length of the substantially strip-shaped protrusions and/or the (maximum) width and/or (maximum) length of the substantially strip-shaped depressions can be determined, for example, by means of SEM (scanning electron microscopy). The width is typically measured at half height and perpendicular to the local longitudinal direction of the depressions or protrusions. The maximum width can be regarded as the largest width of the respective depression or protrusion that can be measured in this way. The length is typically measured along the longitudinal direction (or course) of the depressions or protrusions. The maximum length can be regarded as the greatest length of the respective depression or protrusion that can be measured in this way.

The nanostructures are in the form of substantially dot-shaped protrusions. Furthermore, the nanostructures or the substantially dot-shaped protrusions are arranged at least on the substantially strip-shaped protrusions. In addition, the nanostructures in the form of substantially dot-shaped protrusions can also be arranged on (or in) the substantially strip-like depressions. However, it is possible that the nanostructures in the form of substantially dot-shaped protrusions are arranged exclusively on the substantially strip-shaped protrusions. Substantially dot-shaped can be understood here (and in principle in the context of the entire present disclosure) to mean that the length of the respective protrusion does not differ at all or does not differ significantly from the width of the respective protrusion, the length of the respective protrusion optionally being at most 3 times, optionally at most 2 times, as great as the width of the respective protrusion. A respective circumferential edge of the substantially dot-shaped protrusions can, for example, be substantially round (or circular), substantially elliptical or substantially oval.

In the context of the entire present disclosure, the length and/or width of the substantially dot-shaped protrusions can be determined, for example, by means of SEM (scanning electron microscopy). The length is typically measured along the longest (perpendicular to the surface) expansion direction of the protrusion. The width is typically measured along the direction perpendicular to this longest extension direction of the protrusion.

Optionally, the nanostructures are arranged in the form of the substantially dot-shaped protrusions on the interfaces of the substantially strip-shaped protrusions. Here, the boundary surface of the respective protrusion represents the entire surface region of the respective protrusion that lies above half the height of the protrusion, measured between the lowest point of an adjacent depression and the highest point of the protrusion. The interfaces of the substantially strip-shaped protrusions can be determined using SEM (scanning electron microscopy), for example.

The at least two first surface regions can each have, in sections, a linear course and/or a non-linear, for example wavy, course. For example, the at least two first surface regions can each have an (essentially) linear profile or a non-linear, for example wavy, profile.

In step c) of the method according to the present disclosure, at least one second surface region of the at least one sealing bead is provided (or coated) with at least one elastomeric sealing element. Here, at least one apolar liquid coating material is applied to the at least one second surface region. The at least one apolar liquid coating material comprises at least one component forming at least one elastomer and optionally at least one cross-linking agent or consists thereof. The at least one component forming at least one elastomer can be understood to be a component that can be crosslinked to form at least one elastomer, i.e. a component from which at least one elastomer is formed by crosslinking. The at least one component forming at least one elastomer can also be referred to as at least one elastomer precursor (which can be crosslinked to form at least one elastomer). The at least one second surface region is arranged between the at least two first surface regions and is directly adjacent to the at least two first surface regions.

The at least one elastomeric sealing element can be formed from the applied apolar liquid coating material, for example by at least partially cross-linking the applied coating material. This at least partial cross-linking can be triggered, for example, by a temperature jump, e.g. by an increase to a second temperature, or by UV radiation.

Optionally, the at least one sealing bead comprises several sealing beads. In other words, in step a) at least one metallic layer with several sealing beads formed therein may be provided.

An embodiment of the method according to the present disclosure is characterized in that
the pulse duration of the laser pulses is less than 100 ps, optionally less than 50 ps, and/or
the fluence (or a fluence) introduced into the at least two first surface regions by irradiation with the laser pulses is in a range from 15 J/cm² to 120 J/cm², optionally from 20 J/cm² to 100 J/cm², optionally from 25 J/cm² to 80 J/cm².

A further embodiment of the method according to the present disclosure is characterized in that step c) is carried out no later than 72 h after step b), optionally no later than 24 h after step b), optionally no later than 6 h after step b), optionally no later than 3 h after step b), optionally no later than 1 h after step b), for example directly after step b). In this way, it can be ensured that the hydrophilic properties of the surface structurings are still present to a sufficient extent when step c) is carried out, since excessive aging of the surface structurings can result in a reduction or loss of the hydrophilic properties of the surface structurings. The aged surface structurings also exhibit the periodic structures, which comprise the alternately arranged substantially strip-shaped protrusions and depressions, as well as the nanostructures in the form of substantially dot-shaped protrusions, which are arranged (at least) on the substantially strip-shaped protrusions. However, as the surface structurings age, the surface density of the nanostructures on the substantially strip-shaped protrusions can increase. The areal density of the nanostructures is understood here as the proportion of the area of the total area of the substantially strip-shaped protrusions that the nanostructures occupy or cover in the form of dot-shaped protrusions.

In some embodiments, the pulse duration is less than 100 ps, less than 50 ps, less than 20 ps, less than 10 ps, or even less than 1 ps. In some embodiments, pulse durations in the fs range are used, e.g. greater than 30 fs and/or less than 1000 fs, optionally greater than 50 fs and/or greater than 100 fs. Optionally, picosecond or femtosecond lasers can be used for the method, these being referred to collectively as ultrashort-pulse lasers.

In particular, the surface structures can be created by the interaction of the incident laser radiation with the irradiated surface. The interaction leads to a spatially modulated energy coupling into the material, which subsequently leads to surface structuring. Typically, a or the fluence of the laser radiation is in the order of magnitude of the ablation threshold of the metallic plate material used. The fluence can be selected, for example, so that it deviates by no more than 20% from the ablation threshold of the material used for the at least one metallic plate. The fluence is a measure of the energy density of the laser pulses and is usually specified in J/cm². The fluence can optionally be at least 15 J/cm², optionally at least 20 J/cm², optionally at least 25 J/cm², and/or at most 120 J/cm², optionally at most 100 J/cm², optionally 80 J/cm².

A further embodiment of the method according to the present disclosure is characterized in that
the substantially strip-shaped protrusions have a width in the range from 250 nm to 700 nm, optionally from 350 nm to 600 nm, and/or the substantially strip-shaped depressions have a width in the range from 100 nm to 550 nm, optionally from 200 nm to 450 nm, and/or
the nanostructures (in each case) have an average diameter in the range from 10 nm to 200 nm, optionally from 30 nm to 150 nm, optionally from 50 nm to 120 nm, and/or
the nanostructures (in each case) have a maximum diameter in the range from 10 nm to 300 nm, optionally from 30 nm to 250 nm, optionally from 50 nm to 200 nm, and/or
the nanostructures each have a surface area in the range from 80 nm² to 40,000 nm², optionally from 800 nm² to 20,000 nm², optionally from 2,000 nm² to 10,000 nm², and/or
the areal density of the nanostructures on the substantially strip-shaped protrusions is in the range from 1 to 10%, optionally from 2 to 6%.

The width of the substantially strip-shaped protrusions and/or the width of the substantially strip-shaped depressions can, for example, be determined as described above.

Optionally, the substantially strip-shaped depressions can have a depth in the range of 0.05 to 0.7 μm. The depth refers to the extension perpendicular to the panel plane below half the height. Accordingly, the substantially strip-shaped protrusions can have a height in the range of 0.05 to 0.7 μm. The height refers to the extension perpendicular to the panel plane above half the depth. The depth of the substantially strip-shaped depressions and the height of the substantially strip-shaped protrusions can, for example, be determined using SEM (scanning electron microscopy), for example FIB SEM (scanning electron microscopy with focused ion beam). For example, the depth of the substantially strip-shaped depressions can vary along the course of the individual depressions, as can the height of the substantially strip-shaped protrusions along the course of the individual protrusions.

The (respective) average diameter and the (respective) maximum diameter of the nanostructures can be determined using SEM (scanning electron microscopy), for example. The diameter is typically measured as a (linear) spatial distance running through the center of the respective nanostructure between a first point of the outer edge of the respective nanostructure and a second point of the outer edge of the nanostructure opposite the first point. The mean diameter can then be determined by averaging several measured diameter values (each for one nanostructure). For example, the nanostructures can (in each case) have a minimum diameter in the range from 5 to 60 nm, optionally from 10 to 55 nm, optionally from 15 to 50 nm. Optionally, the diameter of the individual nanostructures can vary from nanostructure to nanostructure over a certain range, i.e. the nanostructures can be of different sizes.

The respective surface area of the nanostructures can be determined using SEM (scanning electron microscopy), for example. The area size of a nanostructure can be understood as the size of the area that the nanostructure covers or occupies in the top view of the surface on which it is located. Optionally, the respective area size of the individual nanostructures can vary from nanostructure to nanostructure over a certain range, i.e. the nanostructures can be of different sizes.

According to a further embodiment of the method according to the present disclosure, the at least one metallic layer is formed from stainless steel and/or at least one titanium alloy, for example from a stainless-steel core with at least one surface of a titanium alloy.

A further embodiment of the method according to the present disclosure is characterized in that
providing the at least one second surface region with the at least one elastomeric sealing element comprises using a method selected from the group consisting of screen printing method, roller printing method, stencil printing method, dispensing method (i.e. method for application by means of a dispenser), and combinations thereof, and/or
the at least one elastomer is selected from the group consisting of fluoro rubbers, silicone rubbers, nitrile-butadiene rubbers, polyurethanes, natural rubbers, perfluoro rubbers, styrene-butadiene rubbers, butyl rubbers, fluorosilicone rubbers, chlorosulfonated polyethylene, silicone resins, epoxy resins, hydrogenated nitrile-butadiene rubbers, ethylene-propylene-diene rubbers, olefin-based resins, polyisobutylenes, ethyl-2-cyanoacrylate, and mixtures thereof.

The elastomers mentioned are particularly suitable as sealing materials.

According to a further embodiment of the method according to the present disclosure, the at least one apolar liquid coating material is at least one foamable material that additionally comprises expandable microspheres, wherein, after application of the apolar liquid coating material to the at least one second surface region, the at least one elastomeric sealing element is formed by expansion of the microspheres, wherein the microspheres
have an average diameter of at least 5 μm and/or at most 50 μm in the unexpanded state, and/or
have an average diameter of at least 20 μm and/or at most 150 μm in the expanded state.

Alternatively, the at least one apolar liquid coating material can also be a foamable material that does not comprise expandable microspheres but rather, for example, another blowing agent, or can be a non-foamable material.

A further embodiment of the method according to the present disclosure is characterized in that
the at least two first surface regions and/or the at least one second surface region extend substantially parallel to (that is, along) a main direction of extension of the respective sealing bead and/or extend over the entire length or the entire course of the respective sealing bead, and/or
the at least two first surface regions each have a width (over the entire length of the respective surface region) in the range from 90 μm to 460 μm, optionally from 95 μm to 300 μm, optionally from 100 μm to 200 μm.

The respective width of the at least two first surface regions can, for example, be determined using SEM (scanning electron microscopy) as described above.

A further embodiment of the method according to the present disclosure is characterized in that the at least one sealing bead has a respective bead roof (running along the course of the respective sealing bead) and respective first and second bead flanks adjacent to the bead roof (running along the course of the sealing bead), wherein
at least one of the at least two first surface regions is arranged on an edge of the first bead flank that directly adjoins the bead roof and/or on the bead roof, optionally on an edge of the bead roof that directly adjoins the first bead flank, and
at least one further first surface region of the at least two first surface regions is arranged on an edge of the second bead flank that directly adjoins the bead roof and/or on the bead roof, optionally on an edge of the bead roof that directly adjoins the second bead flank, and/or
the at least one second surface region is arranged on the bead roof, and/or
the at least one second surface region is arranged exclusively on the bead roof, and/or
the at least one second surface region extends over the entire width of the bead roof or partially over the width of the bead roof.

The fact that at least one of the at least two first surface regions is arranged on an edge of the first bead flank that directly adjoins the bead roof and at least another one of the at least two first surface regions is arranged on an edge of the second bead flank that directly adjoins the bead roof means that the entire bead roof is coated (that is, the bead roof is coated over its entire width) without some of the coating material getting onto the bead flanks. This prevents losses in the final height of the elastomer sealing element and the resulting higher leakage rates as well as rejects of components that do not seal adequately as a result. This also allows the maximum available width of the bead roof surface to be utilized, thus ensuring the maximum possible sealing width of the elastomer sealing element. Laterally adjacent to the bead flanks, the sealing bead has bead feet that delimit it and are therefore no longer part of the sealing bead itself.

Optionally, the bead roof of the respective sealing bead has no curvature (that is, bead roof of the respective sealing bead is flat) or the bead roof of the respective sealing bead has a curvature with a radius of at least 1 mm, optionally at least 2 mm. However, the radius is usually larger, for example it can be up to 15 mm. The bead roof can also have several curvatures in its width, for example alternating convex and concave curvatures. The individual curvatures can be identical or different.

Optionally, the bead flanks of the respective sealing bead each have a minimum angle to the bead feet in the range from 15° to 75°, optionally from 25° to 65°.

Optionally, the bead flanks of the respective sealing bead are tangentially connected to the bead roof of the respective sealing bead with a radius of at least 0.05 mm, optionally at least 0.2 mm. This radius can (essentially) be considered part of the bead flank.

Optionally, the bead flanks of the respective sealing bead are each tangentially connected to the bead feet with a radius of at least 0.05 mm, optionally at least 0.2 mm.

According to a further embodiment of the method according to the present disclosure, the at least one second surface region is provided, before step c), optionally before step b), with a further surface structuring which has a plurality of further depressions, wherein the further depressions optionally
have a width and/or a diameter in the range from 10 μm to 150 μm, optionally from 20 μm to 100 μm, optionally from 30 μm to 70 μm, and/or
have a depth of at least 2 μm and/or at most 40 μm and/or have a depth of at most 20% of the thickness of the metallic layer, and/or
are produced by laser radiation, optionally by irradiation using a pulsed laser, or by microstructuring embossing.

The further surface structuring differs from the surface structuring created on the at least two first surface regions. Thus, the further surface structuring is not a surface structuring which has periodic structures which comprise alternately arranged substantially strip-shaped protrusions and depressions, as well as nanostructures in the form of substantially dot-shaped protrusions which are arranged (at least) on the substantially strip-shaped protrusions. Optionally, the further depressions differ from the substantially strip-shaped depressions of the periodic structures.

The further surface structuring can improve the adhesion of the at least one elastomeric sealing element to the metallic layer, in particular if the at least one apolar liquid coating material is at least one foamable material which additionally comprises expandable microspheres.

The width and/or diameter of the additional depressions of the further surface structuring can be determined using SEM (scanning electron microscopy), for example. The width and/or diameter can be measured, for example, at half the height of the depressions and/or parallel to the untreated surface of the metal layer. The depth of further depressions can be determined using SEM (scanning electron microscopy), for example. The depth can be measured, for example, from the untreated surface of the metallic layer to the deepest point of the depression. The untreated surface is a surface directly adjacent to another depression or its surroundings, which may appear to be raised. If the additional depression is on a bead roof, this untreated surface is also part of the bead roof.

The depth of the additional depressions, which are deeper than the surface structuring with strip-shaped protrusions and depressions, is no more than 20% of the thickness of the metallic layer. This ensures that the metallic layer does not exhibit any material weakening that could lead to leaks or breakage of the material during operation.

The further depressions are optionally created using laser radiation. Alternatively, the further depressions can be created mechanically, e.g. by embossing or carving into the metallic layer. With regard to the further aspects of the process steps for producing the further depressions and the resulting geometries and properties of the further depressions and the structures surrounding them, reference is made to DE 10 2021 204 497, which is, in its entirety, hereby incorporated by reference into this document.

A further embodiment of the method according to the present disclosure is characterized in that the component for an electrochemical cell is a bipolar plate or a separator plate for an electrochemical system, optionally for a fuel cell, for a fuel cell stack or for an electrolysis system; or a sealing frame for an electrochemical system, optionally for an electrolysis system. Optionally, the electrochemical system is an electrochemical cell or a stack comprising several electrochemical cells.

Furthermore, the present disclosure also relates to a component for an electrochemical system, comprising at least one metallic layer with at least one sealing bead molded therein, wherein the at least one sealing bead has at least two first surface regions and at least one second surface region arranged between the at least two first surface regions and directly adjoining the at least two first surface regions, wherein the at least two first surface regions have surface structurings (i.e. one surface structuring each) that comprise periodic structures that are arranged alternately in the form of substantially strip-like protrusions and depressions, as well as nanostructures in the form of substantially dot-shaped protrusions that are arranged (at least) on the substantially strip-shaped protrusions, and wherein the at least one second surface region is at least one surface region provided with at least one elastomeric sealing element (that is, at least one surface region having at least one elastomeric sealing element).

Due to the fact that the at least two first surface regions have surface structurings (that is, each first surface region has one surface structuring), the at least two first surface regions are surface-structured surface regions. Optionally, the at least two first surface regions are at least two laser-treated surface regions.

The surface structurings may be produced by at least one laser treatment. The at least one laser treatment may have been carried out in accordance with the respective previously indicated embodiments relating to the method according to the present disclosure.

In addition, the at least one elastomeric sealing element may be produced by a process in which at least one apolar liquid coating material comprising at least one component forming at least one elastomer (or at least one elastomer precursor) was first applied to the at least one second surface region. The application may be carried out by a method selected from the group consisting of screen printing method, roller printing method, stencil printing method, dispensing method (i.e. method for application by means of a dispenser), and combinations thereof.

The surface structurings have periodic structures and nanostructures. The periodic structures extend over the entire surface-structured surface regions, i.e. over the entire at least two first surface regions.

The periodic structures and the nanostructures may be formed as previously described in the context of the method according to the present disclosure, whereby the explanations there apply analogously here.

The at least one metallic layer can, for example, be at least one metallic plate or at least one metallic frame, each comprising a sealing bead. Optionally, the at least one metallic plate comprises two metallic plates that are joined together, e.g. welded together. The two metallic plates can be separator plates, e.g. separator plates of a bipolar plate. If the two metallic plates are not joined together (during steps a) to c) of the process), the two metallic plates can be joined together, e.g. welded together, after step c), to form a bipolar plate. A frame can be applied to or arranged around a separator plate of an electrochemical system.

Optionally, the at least one sealing bead comprises several sealing beads. In other words, the at least one metallic layer may be at least one metallic layer with several sealing beads formed therein.

An embodiment of the component according to the present disclosure is characterized by the fact that
the substantially strip-shaped protrusions have a width in the range from 250 nm to 700 nm, optionally from 350 nm to 600 nm, and/or the substantially strip-shaped depressions have a width in the range from 100 nm to 550 nm, optionally from 200 nm to 450 nm, and/or
the nanostructures (in each case) have an average diameter in the range from 10 nm to 200 nm, optionally from 30 nm to 150 nm, optionally from 50 nm to 120 nm, and/or
the nanostructures (in each case) have a maximum diameter in the range from 10 nm to 300 nm, optionally from 30 nm to 250 nm, optionally from 50 nm to 200 nm, and/or
the nanostructures each have a surface area in the range from 80 nm² to 40,000 nm², optionally from 800 nm² to 20,000 nm², optionally from 2,000 nm² to 10,000 nm², and/or
the areal density of the nanostructures on the substantially strip-shaped protrusions is in the range from 1 to 10%, optionally from 2 to 6%.

The width of the substantially strip-shaped protrusions and/or the width of the substantially strip-shaped depressions can be determined, for example, as described in the context of the method according to the present disclosure.

The (respective) mean diameter and the (respective) maximum diameter of the nanostructures can be determined, for example, as described in the context of the method according to the present disclosure.

The respective area size of the nanostructures can be determined, for example, as described in the context of the method according to the present disclosure, whereby what is said in the context of the method according to the present disclosure with regard to variations and bandwidths applies analogously.

The areal density of the nanostructures can be determined, for example, as described in the context of the method according to the present disclosure, whereby the explanations there apply analogously here.

According to a further embodiment of the component according to the present disclosure, the at least one metallic layer is formed from stainless steel and/or at least one titanium alloy, for example from a stainless-steel core with at least one surface made of a titanium alloy.

A further embodiment of the component according to the present disclosure is characterized in that the at least one elastomeric sealing element
contains at least one elastomer selected from the group consisting of fluoro rubbers, silicone rubbers, nitrile-butadiene rubbers, polyurethanes, natural rubbers, perfluoro rubbers, styrene-butadiene rubbers, butyl rubbers, fluorosilicone rubbers, chlorosulfonated polyethylene, silicone resins, epoxy resins, hydrogenated nitrile-butadiene rubbers, ethylene-propylene-diene rubbers, olefin-based resins, polyisobutylenes, ethyl-2-cyanoacrylate, as well as mixtures thereof, and/or
contains or consists of a foamed material with microspheres, wherein optionally an average diameter of the microspheres is at least 20 μm and/or at most 80 μm.

The elastomers mentioned are particularly suitable as sealing materials.

Optionally, the at least one elastomeric sealing element can contain or consist of a foamed material with microspheres. Alternatively, the at least one elastomeric sealing element may also contain or consist of a foamable material which does not comprise expandable microspheres, or contain or consist of a non-foamable material.

A further embodiment of the component according to the present disclosure is characterized by the fact that
the at least two first surface regions and/or the at least one second surface region run essentially parallel to a main direction of extension of the respective sealing bead and/or extend over the entire length or the entire course of the respective sealing bead, and/or
the at least two first surface regions each have a width in the range from 90 μm to 460 μm, optionally from 95 μm to 300 μm, optionally from 100 μm to 200 μm.

The respective width of the at least two first surface regions can be determined, for example, as described in the context of the method according to the present disclosure. For example, it is possible that the respective width of the at least two first surface regions varies along their course.

According to a further embodiment of the component according to the present disclosure, the at least one sealing bead has a respective bead roof (extending along the course of the respective sealing bead) and respective first and second bead flanks adjacent to the bead roof (extending along the course of the respective sealing bead), wherein
at least one of the at least two first surface regions is arranged on an edge of the first bead flank that directly adjoins the bead roof and/or on the bead roof, optionally on an edge of the bead roof that directly adjoins the first bead flank, and
at least one further first surface region of the at least two first surface regions is arranged on an edge of the second bead flank that directly adjoins the bead roof and/or on the bead roof, optionally on an edge of the bead roof that directly adjoins the second bead flank, and/or
the at least one second surface region is arranged on the bead roof, and/or
the at least one second surface region is arranged exclusively on the bead roof, and/or
the at least one second surface region extends over the entire width of the bead roof or partially over the width of the bead roof.

The at least one second surface region may extend over the entire width of the bead roof. This allows the maximum available width of the bead roof surface to be utilized and thus ensures the maximum possible sealing width of the elastomer sealing element. The at least one second surface region may be arranged exclusively on the bead roof, as this allows a very good sealing effect to be achieved with low material consumption. Overall, the at least one second surface region may be arranged exclusively on the bead roof and extend over the entire width of the bead roof, as this enables a particularly good sealing effect.

Laterally adjacent to the bead flanks, the sealing bead has bead feet that delimit it and are therefore no longer part of the sealing bead itself.

The bead roof, that is the bead roofs and/or the bead flanks, can be configured as previously described in the context of the method according to the present disclosure, whereby the explanations there apply analogously here.

A further embodiment of the component according to the present disclosure is characterized in that the at least one second surface region under the at least one elastomeric sealing element has a further surface structuring with a plurality of further depressions, wherein optionally the further depressions
have a width and/or a diameter in the range from 10 μm to 150 μm, optionally from 20 μm to 100 μm, optionally from 30 μm to 70 μm, and/or
have a depth of at least 2 μm and/or at most 40 μm and/or have a depth of at most 20% of the thickness of the metallic layer, and/or
have been produced by laser radiation, optionally by irradiation using a pulsed laser, or by microstructuring embossing.

The further surface structuring differs from the surface structurings exhibited by the at least two first surface regions. Thus, the further surface structuring is not a surface structuring that has periodic structures that comprise alternately arranged substantially strip-shaped protrusions and depressions, as well as nanostructures in the form of substantially dot-shaped protrusions that are arranged (at least) on the substantially strip-shaped protrusions. The further depressions may differ from the substantially strip-shaped depressions of the periodic structures.

The further surface structuring can improve the adhesion of the at least one elastomeric sealing element to the metallic layer, in particular if the at least one elastomeric sealing element contains a foamed material with microspheres.

The width and/or diameter of the further depressions can be determined using SEM (scanning electron microscopy) or SEM images, for example. The width and/or diameter can be measured, for example, at half the height of the depressions and/or parallel to the untreated surface of the metal layer. The depth of the further depressions can be determined using SEM (scanning electron microscopy), for example. The depth can be measured, for example, from the untreated surface of the metallic layer to the deepest point of the depression. The untreated surface is a surface directly adjacent to another depression or its surroundings, which may appear to be raised. If the further depression is on a bead roof, this untreated surface is also part of the bead roof.

The depth of the further depressions, which are deeper than the surface structuring with strip-shaped protrusions and depressions, is no more than 20% of the thickness of the metallic layer. This ensures that the metallic layer does not exhibit any material weakening that could lead to leaks or fractures in the material during operation.

With regard to the further properties, in particular geometric properties, of the further depressions and the structures surrounding them, reference is made to DE 10 2021 204 497, which is hereby incorporated into this document by reference.

The further depressions can optionally be created using laser radiation. Alternatively, the further depressions can also be created mechanically, e.g. by embossing or carving into the metallic layer.

A further embodiment of the component according to the present disclosure is characterized in that the component is a bipolar plate or a separator plate for an electrochemical system, optionally for a fuel cell or for a fuel cell stack or for an electrolysis cell, or a sealing frame for an electrochemical system, optionally for an electrolysis cell. Optionally, the electrochemical system is an electrochemical cell or a stack comprising several electrochemical cells.

According to a further embodiment of the component according to the present disclosure, the component can be produced or is produced using the method according to the present disclosure.

The present disclosure also relates to an electrochemical system comprising at least one component according to the present disclosure. Optionally, the electrochemical system is an electrochemical cell, e.g. a fuel cell or an electrolysis cell, or a stack comprising several electrochemical cells, e.g. a fuel cell stack or an electrolyzer stack.

The following figures and examples are intended to explain the present disclosure in more detail, without limiting it to the specific embodiments and parameters shown here.

### BRIEF DESCRIPTION OF THE FIGURES

FIG. 1 shows a schematic perspective view of an electrochemical system with a large number of bipolar plates arranged in a stack.

FIG. 2A shows a schematic perspective view of two bipolar plates of the system according to FIG. 1 with a membrane electrode assembly (MEA) arranged between the bipolar plates.

FIG. 2B schematically shows the structure of an electrolytic cell with two separator plates and a sealing frame.

FIG. 3A shows a schematic cross-section through a section of an electrochemical system 1 according to the prior art of the type of system 1 shown in FIG. 1.

FIG. 3B shows an enlarged view of section III from FIG. 3A.

FIG. 4A shows a schematic cross-section through a section of an electrochemical system 1 of the type of system 1 in FIG. 1.

FIG. 4B shows an enlarged view of section IV from FIG. 4A.

FIG. 5A shows an SEM image of the surface structuring of one of the first surface regions.

FIG. 5B shows an enlarged view of a section of the SEM image from FIG. 5A.

FIG. 6A shows an SEM image of the surface structuring of one of the first surface regions after aging.

FIG. 6B shows an enlarged view of a section of the SEM image from FIG. 6A.

FIG. 7 shows an SEM image of the surface structuring of one of the first surface regions.

FIG. 8A schematically shows a cross-section of a portion of a metallic layer in the form of a metallic plate 2c during the implementation of an exemplary embodiment of the method according to the present disclosure for producing a component for electrochemical system 1.

FIG. 8B schematically shows a cross-section of a section of a metallic layer in the form of a metallic plate 2c during the implementation of an exemplary embodiment of the method according to the present disclosure for producing a component for electrochemical system 1.

FIG. 9 schematically shows a cross-section of a section of a metallic layer in the form of a metallic plate 2c during the implementation of an exemplary embodiment of the method according to the present disclosure for producing a component for electrochemical system 1.

FIG. 10 shows an SEM image of the further surface structuring of the second surface region.

FIG. 11 schematically shows a cross-section of a section of a metallic layer in the form of a metallic plate 2c during the implementation of an exemplary embodiment of the method according to the present disclosure for producing a component for electrochemical system 1.

FIG. 12A shows a schematic top view of a section of a metallic layer in the form of a metallic plate 2c, as shown in FIG. 11.

FIG. 12B shows a schematic top view of a section of a metallic layer in the form of a metallic plate 2c, as shown in FIG. 11.

FIG. 13 shows a flow chart of the method according to the present disclosure.

### DETAILED DESCRIPTION

Here and below, features that recur in different figures are denoted in each case by the same or similar reference signs.

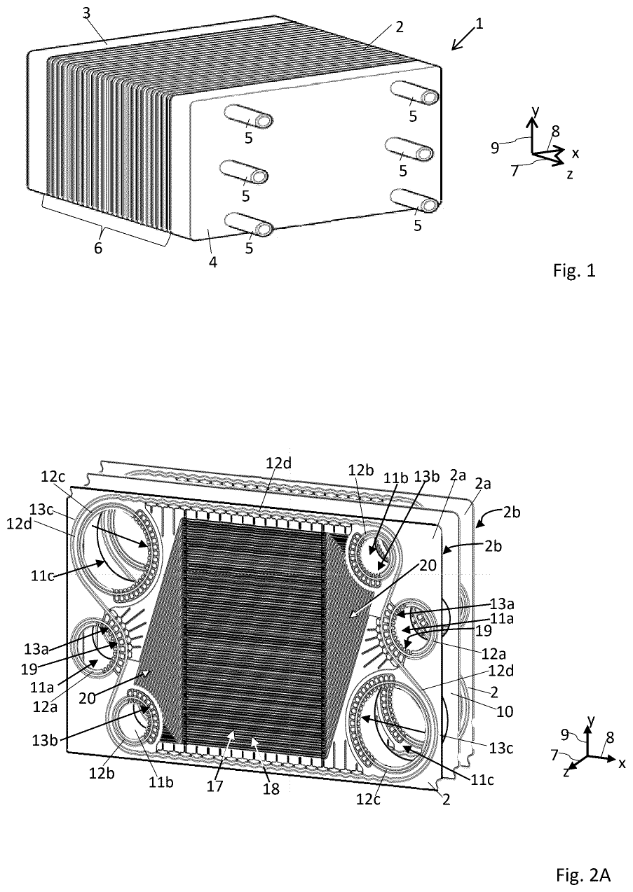

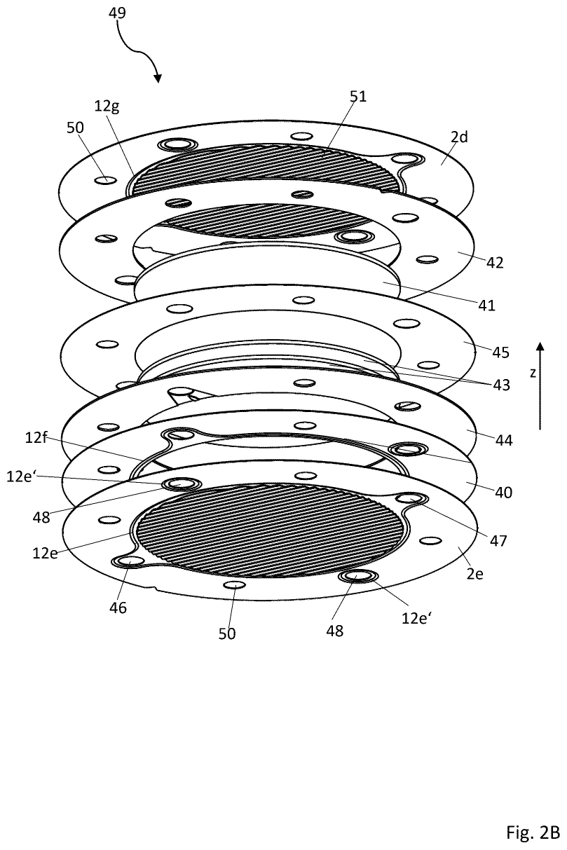

FIG. 1 shows an electrochemical system 1 with a plurality of identically constructed metallic bipolar plates 2 which are arranged in a stack 6 and are stacked along a z-direction 7. The bipolar plates 2 of the stack 6 are clamped between two end plates 3, 4. The z-direction 7 is also called the stacking direction. In the present example, the system 1 is a fuel cell stack. Two adjacent bipolar plates 2, that is the separator plates 2a, 2b facing each other of each of these bipolar plates 2 of the stack thus delimit an electrochemical cell, which is used, for example, to convert chemical energy into electrical energy. To form the electrochemical cells of system 1, a membrane electrode assembly (MEA) is arranged between adjacent bipolar plates 2 of the stack (see e.g. FIG. 2A). The MEA typically contains at least one membrane, e.g. an electrolyte membrane. Furthermore, a gas diffusion layer (GDL) may be arranged on one or both surfaces of the MEA.

In alternative embodiments, the system 1 may also be configured as an electrolyzer, as an electrochemical compressor, or as a redox flow battery. Bipolar plates can likewise be used in these electrochemical systems. The structure of these bipolar plates may then correspond to the structure of the bipolar plates 2 explained in detail here, although the media guided on and/or through the bipolar plates in the case of an electrolyzer, an electrochemical compressor or a redox flow battery may differ in each case from the media used for a fuel cell system.

The z-axis 7, together with an x-axis 8 and a y-axis 9, spans a right-handed Cartesian coordinate system. The bipolar plates 2 each define a plate plane, each of the plate planes of the separator plates 2a, 2b of the bipolar plates 2 being oriented parallel to the x-y plane and thus perpendicular to the stacking direction or to the z-axis 7. The end plate 4 comprises a plurality of media connections 5, via which media can be fed to the system 1 and via which media can be discharged from the system 1. These media that can be supplied to and discharged from system 1 can include, for example, fuels such as molecular hydrogen or methanol, reaction gases such as air or oxygen, reaction products such as water vapor or depleted fuels, or coolants such as water and/or glycol.

FIG. 2A shows a perspective view of two adjacent bipolar plates 2 of an electrochemical system of the type of system 1 in FIG. 1 and a membrane electrode assembly (MEA) 10 known from the prior art arranged between these adjacent bipolar plates 2, the MEA 10 in FIG. 2A being largely concealed by the bipolar plate 2 facing the viewer. The bipolar plate 2 is formed of two separator plates 2a, 2b which are joined together in a materially bonded manner, of which only the first separator plate 2a facing the viewer is visible in FIG. 2A, said first separator plate concealing the second separator plate 2b. The separator plates 2a, 2b can each be made from a metal sheet, e.g. a stainless-steel sheet. The separator plates 2a, 2b can, for example, be welded together, e.g. by laser welding.

The separator plates 2a, 2b have through-openings, which are aligned with one another and form the through-openings 11a-c of the bipolar plate 2. When stacking a plurality of bipolar plates of the type of bipolar plate 2, the through-openings 11a-c form ducts that extend through the stack 6 in the stacking direction (or z-direction 7) (see FIG. 1). Typically, each of the ducts formed by the through-openings 11a-c is fluidically connected to one of the media ports 5 in the end plate 4 of the system 1. Coolant, for example, can be fed into the stack or discharged from the stack via the ducts formed by the through-openings 11a. By contrast, the ducts formed by the through-openings 11b, 11c may be configured to supply the electrochemical cells of the fuel cell stack 6 of the system 1 with fuel and with reaction gas and to discharge the reaction products from the stack. The media-guiding through-openings 11a-c are substantially parallel to the plate plane.

In order to seal off the through-openings 11a-c with respect to the interior of the stack 6 and with respect to the surrounding environment, the first separator plates 2a usually have sealing arrangements in the form of sealing beads 12a-c, which are each arranged around the through-openings 11a-c and in each case completely surround the through-openings 11a-c. On the rear side of the bipolar plates 2, facing away from the viewer of FIG. 2A, the second separator plates 2b have corresponding sealing beads for sealing off the through-openings 11a-c (not shown).

In an electrochemically active region 18, the first separator plates 2a have, on their front side facing the viewer of FIG. 2A, a flow field 17 with structures for guiding a reaction medium along the front side of the separator plate 2a. These structures are shown in FIG. 2A by a large number of webs and channels running between the webs and delimited by the webs. On the front side of the bipolar plates 2 facing towards the viewer of FIG. 2A, the first separator plates 2a additionally have a distribution or collection region 20. The distribution or collection region 20 comprises structures that are configured to distribute, over the active region 18, a medium that has been conveyed into the distribution or collection region 20 from a first of the two through-openings 11b, and/or to collect or pool a medium flowing from the active region 18 towards the second one of the through-openings 11b. The distribution structures of the distribution or collection region 20 are also given in FIG. 2A by webs and channels running between the webs and delimited by the webs.

The sealing beads 12a-12c generally have passages 13a-13c, of which the passages 13a are formed both on the underside of the upper separator plate 2a and on the upper side of the lower separator plate 2b, while the passages 13b are formed in the upper separator plate 2a and the passages 13c in the lower separator plate 2b. For example, the passages 13a, which are configured here at least partially as localized protrusions of the bead, allow coolant to pass between the through-opening 12a and the distribution area 20 and further to the cavity 19 between the separator plates 2a and 2b in the active area 18. This allows the coolant to enter or leave the distribution area 20 between the separator plates or the cavity 19 in the active region 18. Furthermore, the passages 13b allow a passage of hydrogen between the through opening 12b and the distribution region on the upper side of the separator plate 2a lying on top; these passages 13b are characterized by perforations facing the distribution region and running transversely to the plate plane. Therefore, hydrogen for example flows through the passages 13b from the through-opening 12b to the distribution region on the upper side of the upper separator plate 2a, or in the opposite direction. The passages 13c enable a passage of air for example between the through-opening 12c and the distribution region, so that air reaches the distribution region on the underside of the lower separator plate 2b and is guided out therefrom. The associated perforations are not visible here. The bead passages usually only extend in the region of the bead flanks and not into the area of the bead roof.

The first separator plates 2a typically also each have a further sealing bead 12d in the form of a perimeter bead, which surrounds the flow field 17 of the active region 18, the distribution or collection region 20 and the through openings 11b, 11c and seals these off from the through opening 11a, i.e. from the coolant circuit, and from the environment of the system 1. The second separator plates 2b each comprise corresponding perimeter beads. The structures of the active region 18, the distributing structures of the distribution or collection region 20 and the sealing beads 12a-d are each formed integrally with the separator plates 2a and are integrally formed in the separator plates 2a, for example in an embossing process, deep-drawing process and/or by means of hydroforming. The same applies to the corresponding distribution structures and sealing beads of the second separator plates 2b.

FIG. 2B shows an exploded view of an electrochemical single cell 49, whereby the single cell 49 is part of an electrolyzer. Electrolyzers typically comprise a large number of stacked individual cells 49. The single cell 49 comprises two separator plates 2d and 2e, two cell frames 42 and 44, a sealing frame 40 and a membrane-electrode arrangement 45 with media diffusion structures 41 and 43. For example, the media diffusion structure 43 comprises layers of carbon fleece, while the media diffusion structure 41 comprises metal, e.g. titanium. The separator plate 2d is arranged here, for example, on the anode side of the single cell 49. In the example shown, the separator plate 2e is arranged on the cathode side of the single cell 49. The individual layers are compressed together to form an individual cell. The individual layers each have through-openings 46, 47, 48 arranged in alignment one above the other for the ingress or egress of water, oxygen and hydrogen, as well as positioning holes 50. A flow field of the separator plate 2e is defined by a projection of the cell frame 44 onto the separator plate 2e. A flow field 51 of the separator plate 2d is defined by a projection of the cell frame 42 onto the separator plate 2d. The cell frame 42 has distribution channels (not shown) for distributing the water that is fed in. The through-openings 46, 47 are fluidically connected to the flow field 51 so that a medium can be routed from the through-opening 46 to the flow field 51, or from the flow field 51 to the through-opening 47. The through-openings 46, 47 together with the flow field 51 are surrounded by a sealing bead 12e, which seals this flow region from the external environment. The through-openings 48 are surrounded by their own sealing beads 12e′. Further sealing beads 12f, 12g are formed in the separator plate 2d or the sealing frame 40. The separator plates 2d, 2e and the sealing frame 40 thus form further components within the meaning of this document.

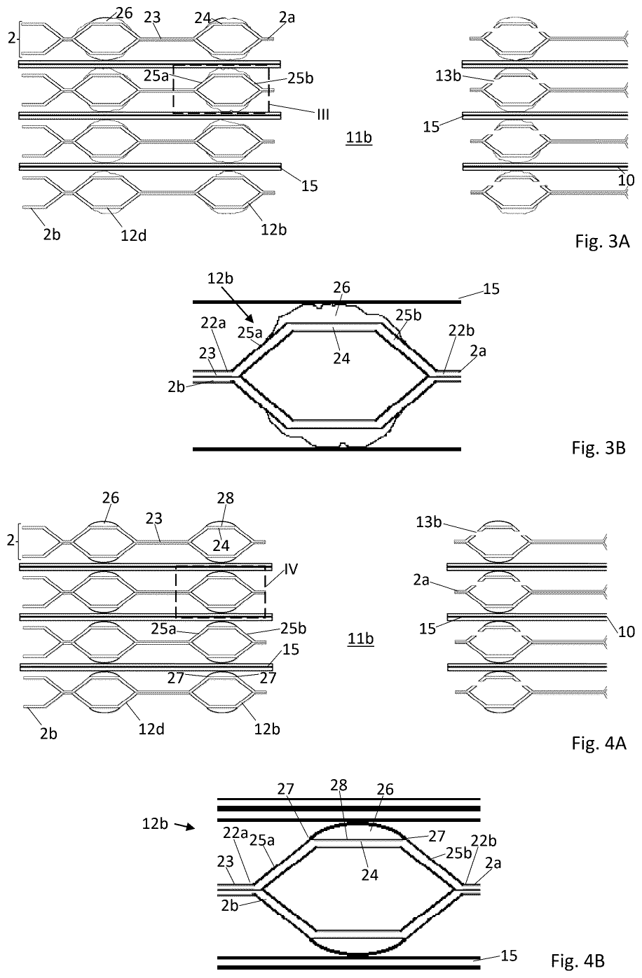

FIGS. 3A and FIG. 4A each show a schematic cross-section through a section of an electrochemical system 1 of the type of system 1 in FIG. 1, the sectional plane in each case being aligned in the z-direction and thus perpendicular to the plate planes of the bipolar plates 2. In FIGS. 3A and 4A (as well as in the detailed illustrations of FIGS. 3B and 4B), cross-sections through two separator plates of a bipolar plate are shown, but the same also applies to components with only one layer, such as a single-layer separator plate 2d, 2e or a single-layer sealing frame 40. In contrast to FIGS. 1-3B, the coatings of the sealing beads are now also shown here.

The electrochemical system in FIG. 3A differs from the electrochemical system in FIG. 4A in terms of the components, for example bipolar plates. Thus, the bipolar plates of the electrochemical system of FIG. 3A are bipolar plates according to the prior art or bipolar plates manufactured according to the prior art, whereas the bipolar plates of the electrochemical system of FIG. 4A are exemplary bipolar plates according to the present disclosure or bipolar plates manufactured according to an exemplary embodiment of the method according to the present disclosure. The various bipolar plates from the electrochemical system in FIG. 3A are identical in construction. The various bipolar plates from the electrochemical system in FIG. 4A are also identical to each other.

The bipolar plates 2 of the system in FIG. 3A and the bipolar plates 2 of the system in FIG. 4A each comprise the first metallic separator plate 2a described above and the second metallic separator plate 2b described above. Each metallic separator plate 2a, 2b can have a material thickness of around 75 μm. Sealing arrangements in the form of sealing beads 12b can be seen, which are arranged around a through-opening 11b. Some of the sealing beads 12b have through-openings 13b. The two separator plates 2a, 2b lie on top of each other in a contact region 23 and are joined together there, in this example by means of laser welds. The metallic separator plates 2a, 2b can, for example, be made of stainless steel and/or at least one titanium alloy, or also of a stainless-steel core with at least one surface made of a titanium alloy.

The cross-sections shown in FIG. 3A and FIG. 4A each show four bipolar plates 2, with a membrane electrode assembly (MEA) 10 arranged between each of the bipolar plates 2, the edge region 15 of which can be seen in the section shown. The MEA 10 typically comprises a membrane (not shown in FIGS. 3A and 4A), e.g. an electrolyte membrane, and a sealing edge region 15 connected to the membrane.

The membrane of the MEA 10 extends at least over and thus defines the active region 18 of the adjacent bipolar plates 2 and enables a proton transfer over or through the membrane. The membrane as such does not extend into the distribution or collection region 20 but only its sealing edge region 15. This sealing edge region 15 of the MEA 10 serves in each case for positioning, fastening and sealing off the membrane between the adjoining bipolar plates 2. If the bipolar plates 2 of the system 1 are clamped between the end plates 3, 4 in the stacking direction (see FIG. 1), the sealing edge region 15 of the MEA 10 can, for example, be pressed between the sealing beads 12a-d of the respective adjacent bipolar plates 2 in order to fix and seal the MEA 10 between the adjacent bipolar plates 2.

The sealing edge region 15 in each case covers the distribution or collection region 20 of the adjoining bipolar plates 2. The edge region 15 can also extend outwards beyond the sealing bead 12d and also beyond the outer edge region of the separator plates 2a, 2b (see FIG. 2A).

FIG. 3B now shows an enlarged view of section III from FIG. 3A, which shows a sealing bead 12b. Accordingly, FIG. 4B shows an enlarged view of section IV from FIG. 4A, which shows a sealing bead 12b. The sealing beads 12b each have a bead roof 24 running along the main direction of extension of the respective sealing bead as well as a first and a second bead flank 25a and 25b each adjoining the bead roof 24 and running along the main direction of extension of the respective sealing bead. Respective bead feet 22a and 22b are laterally connected to the sealing bead 12.

The bead roofs shown in FIGS. 3A/B and FIGS. 4A/B have no curvature (that is, are flat), but can alternatively also have a curvature with a radius of at least 1 mm, optionally of at least 2 mm. The bead roof can also have several curvatures in its cross-section; for example, convex and concave curvatures can alternate. The individual curvatures can be identical or different.

Optionally, the bead flanks 25a and 25b of the respective sealing bead 12b each have a minimum angle to the plane of the bead foot in the range from 15° to 75°, optionally from 25° to 65°.

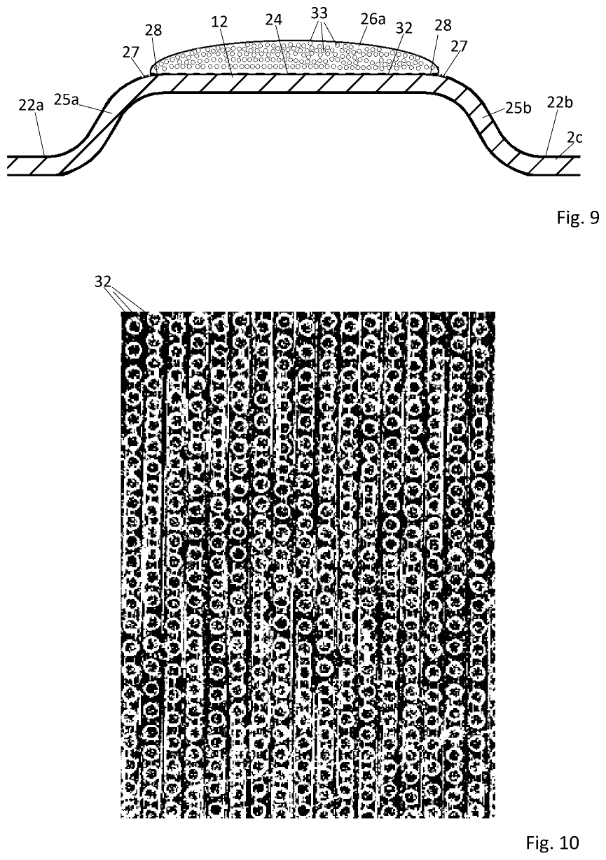

Optionally, the bead flanks 25a and 25b of the respective sealing bead 12b are tangentially connected to the bead roof 24 of the respective sealing bead 12b with a radius that is at least 0.05 mm, optionally at least 0.2 mm. This radius can be considered part of the bead flank 25a, 25b. Corresponding radii are not shown in FIGS. 3A/B and FIGS. 4A/B, but they are clear from FIGS. 8A, 8B and 9.

Optionally, the bead flanks 25a and 25b of the respective sealing bead 12b are each tangentially connected to the bead feet with a radius that is at least 0.05 mm, optionally at least 0.2 mm. Here too, the corresponding radii in FIGS. 3A/B and FIGS. 4A/B are not shown, but they are clear from FIGS. 8A, 8B and 9.

As already mentioned, the bipolar plates 2 of the electrochemical system of FIG. 3A/B are bipolar plates 2 according to the prior art or bipolar plates manufactured according to the prior art. Here, the bipolar plate 2 in FIG. 3A/B has an elastomeric sealing element 26, which has been produced by applying at least one apolar liquid coating material to the bead roofs 24 of the sealing beads 12b, 12d. During and/or after the application of the liquid coating material, it has flowed from the bead roofs 24 of the sealing beads 12b, 12d onto the bead flanks 25a and 25b. As a result, the coating now not only covers the bead roofs 24 but also (partially) the bead flanks 25a and 25b. As a consequence, however, the bipolar plates 2 of the electrochemical system in FIG. 3A/B exhibit losses in the final height of the elastomeric sealing element 26, which results in higher leakage rates. The detailed illustration shows an example of an elastomeric sealing element 26 on the bead 12b of the separator plate 2b, which has a height that is significantly too low, so that leakage occurs here even with a minimal pressure difference.

In contrast to the bipolar plates 2 of the electrochemical system of FIG. 3A/B, the bipolar plates 2 of the electrochemical system of FIG. 4A/B are now exemplary bipolar plates 2 according to the present disclosure or bipolar plates 2 produced using an exemplary embodiment of the method according to the present disclosure. The sealing beads 12b, 12d of these bipolar plates 2 each have two first surface regions 27 and a second surface region 28 arranged between the two first surface regions 27 and directly adjacent to the two first surface regions 27. The second surface region 28 is in each case provided or coated with an elastomeric sealing element 26, wherein the second surface region 28 is arranged exclusively on the bead roof 24 and extends over the entire width of the bead roof 24. One of the two first surface regions 27 is disposed on an edge of the first bead flank 25a immediately adjacent to the bead roof 24 and the other of the two first surface regions 27 is disposed on an edge of the second web flank 25b immediately adjacent to the bead roof 24, each of the two first surface regions 27 being immediately adjacent to the second surface region 28 provided with elastomeric sealing element. In addition, the two first surface regions 27 and the second surface region 28 extend substantially parallel to a main direction of extension of the respective sealing bead 12b, 12d and may extend over the entire length or the entire course of the respective sealing bead 12b, 12d. The two first surface regions 27 can each have a width in the range from 90 μm to 460 μm, optionally from 95 μm to 300 μm, optionally from 100 μm to 200 μm.

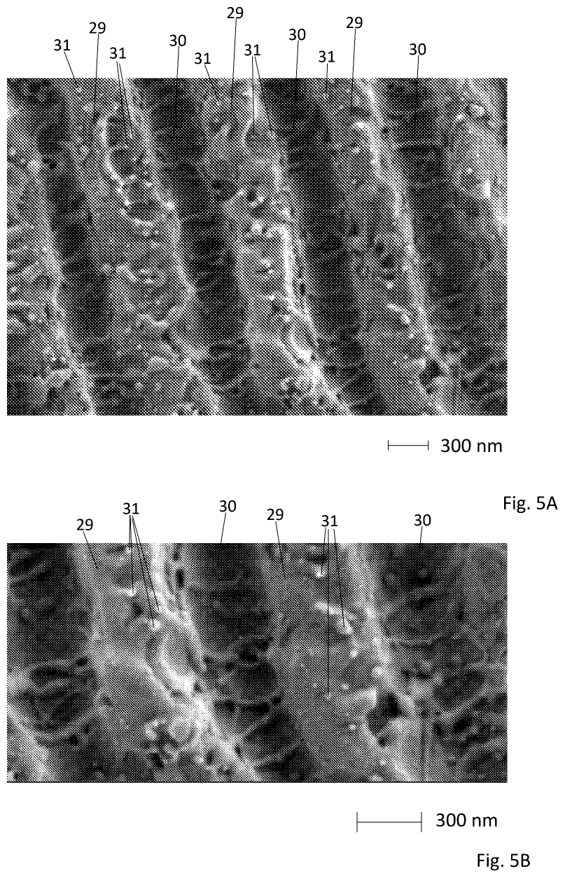

The two first surface areas 27 each have a special surface structure. FIG. 5A shows an SEM image of such a surface structure. FIG. 5B also shows an enlarged view of the SEM image from FIG. 5A. The surface structures of the first two surface regions 27 comprise periodic structures and nanostructures 31, wherein the periodic structures comprise alternately arranged, substantially strip-shaped protrusions 29 and depressions 30 and wherein the nanostructures 31 are formed in the form of substantially dot-shaped protrusions and are arranged (at least) on the substantially strip-shaped protrusions 29. These special surface structures now make it easier to apply the apolar liquid coating material during the manufacture of the bipolar plates 2. Thus, the special surface structurings exhibit hydrophilic, optionally superhydrophilic, properties during the manufacture of the bipolar plate 2 and thus act as a kind of flow stopper for an apolar liquid coating material—often in the form of a suspension—that comprises at least one component forming at least one elastomer or at least one elastomer precursor and optionally at least one crosslinking agent or consists of at least one component forming at least one elastomer or at least one elastomer precursor and optionally at least one crosslinking agent, so that such a coating material applied to the second surface area 28 is applied to the edge of the second surface area 27 immediately adjacent to the two first surface areas 27, so that such a coating material applied to the second surface region 28 stops at the edge of the second surface region 28 immediately adjacent to the two first surface regions 27 and does not flow onto or over the two first surface regions 27. The surface structuring thus acts as a kind of flow stopper for the apolar liquid coating material comprising the at least one component forming the at least one elastomer, so that the elastomeric sealing element 26 is ultimately arranged only on the second surface region 28. This ultimately enables a very precise application of the liquid coating material and thus also coating of the sealing beads with increased accuracy, since it can be achieved that the coating material actually only reaches the area of the respective sealing bead 12b, 12d to be coated, i.e. in the present example the second surface area 28, and thus only this area is coated. In particular, in the present example, the surface structuring on the sealing beads 12b, 12d can prevent the suspension from flowing onto the bead flanks 25a and 25b, even if, for example, the suspension has a relatively low viscosity and thus a relatively high tendency to flow. Accordingly, in the bipolar plates of the electrochemical system shown in FIG. 4A/B, the elastomeric sealing element 26 is only arranged on the bead roofs 24 and not on the bead flanks 25a and 25b. As a result, a very good sealing effect can be achieved with low material consumption. Optionally, the various beads of FIG. 4A have an essentially identical profile of the elastomeric sealing element 26 on their bead roofs 24, which results in an even sealing effect.

In addition, the special surface structures simplify the application of the liquid coating material, as the viscosity and the wet film thickness of the applied coating material no longer need to be adjusted so precisely in order to reduce the risk of the liquid coating material flowing into an area that is not to be coated.

Due to the special surface structuring, the elastomeric sealing element 26 can also optionally have a particularly high thickness on the respective sealing beads 12b, 12d, e.g. a maximum thickness of at least 20 μm, optionally at least 80 μm in the case of foamed material, since the surface structuring allows a larger amount of coating material to be applied to the area to be coated without some of the coating material flowing off. Consequently, a higher wet film thickness, and thus also a higher dry film thickness, can be achieved than in the state of the art.

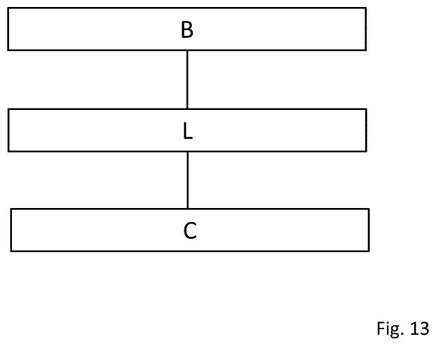

The special surface structurings can be produced by laser treatment, see process step L in the flow chart in FIG. 13. In the laser treatment, the two first surface regions 27 are irradiated by means of a pulsed laser with laser pulses having a pulse duration of less than 1 ns, optionally less than 100 ps, optionally less than 50 ps. Optionally, picosecond or femtosecond lasers, which are collectively referred to as ultrashort pulse lasers, can be used for the laser treatment. Optionally, the fluence introduced into the two first surface regions by irradiation with the laser pulses is in a range from 15 J/cm² to 120 J/cm², optionally from 20 J/cm² to 100 J/cm², optionally from 25 J/cm² to 80 J/cm².

The elastomeric sealing element 26 on the second surface region 28 has been produced by first applying at least one apolar liquid coating material comprising at least one component forming at least one elastomer to the at least one second surface region, see process step C in the flow chart of FIG. 13. This application can optionally be carried out by using a method selected from the group consisting of screen printing methods, roller printing methods, stencil printing methods, dispensing methods (i.e. methods for application by means of a dispenser), and combinations thereof. The formation of the at least one elastomeric sealing element from the applied apolar liquid coating material has taken place, for example, by at least partial cross-linking of the applied coating material. This at least partial cross-linking can be triggered, for example, by a temperature jump, e.g. by an increase to a second temperature, or by UV radiation.

Optionally, providing the second surface region 28 with the elastomeric sealing element 26, in particular the application of the at least one apolar liquid coating material, is performed at the latest 72 h after, optionally at the latest 24 h after, optionally at the latest 6 h after, optionally at the latest 3 h after, optionally at the latest 1 h after, for example directly after, the laser treatment for producing the surface structuring on the two first surface regions 27.

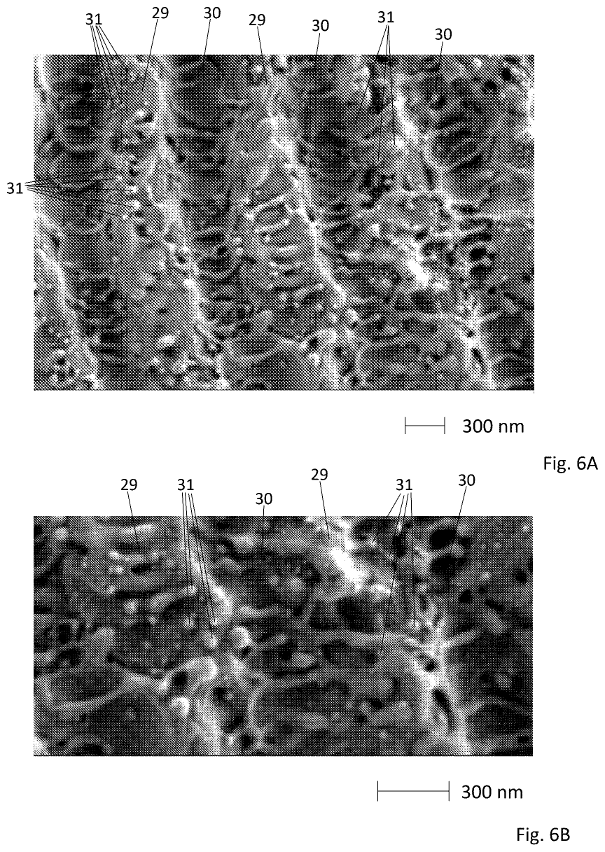

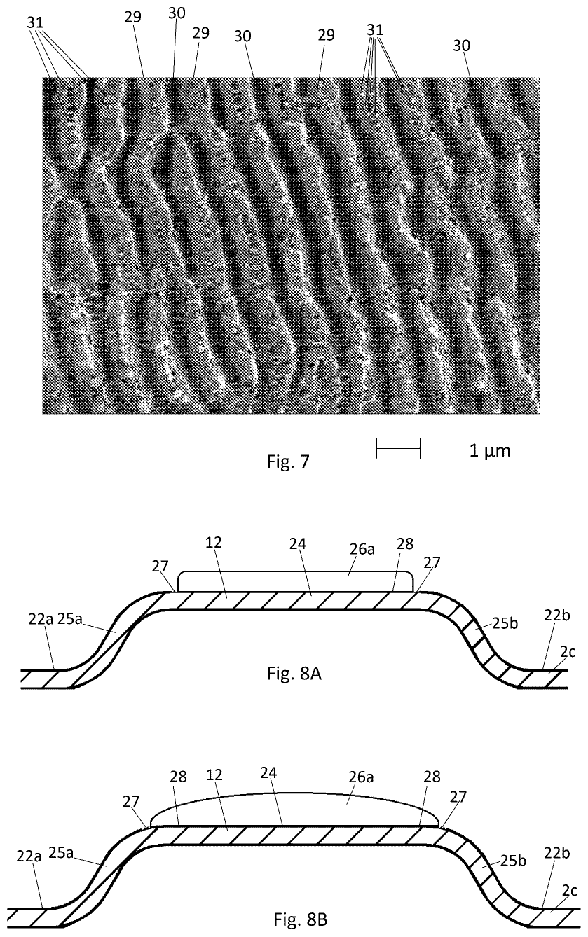

SEM images, as shown in FIG. 5A/B, can be used to characterize the surface structures more precisely. As already mentioned, FIG. 5B shows an enlarged view of a section of the SEM image from FIG. 5A. FIG. 7 also shows another SEM image, which shows a larger section of the surface structuring. FIGS. 5A/5B and 7 show different sections of the same sample shortly after laser treatment, i.e. without significant aging. In addition, FIG. 6A shows an SEM image of the surface structuring after aging, while FIG. 6B shows an enlarged view of a section of the SEM image from FIG. 6A. Again, this is a section of the same sample, but not the same section.

The periodic structures are structures that are arranged periodically in relation to each other in at least one spatial direction. This means that the shape of the periodic structures on the surface is repeated in at least one spatial direction. The average spatial period of the periodic structures is less than 10 μm, optionally no more than 2 μm. The spatial period typically refers to the maximum distance between two neighboring structures of the same or similar shape, i.e., for example, two of the substantially strip-shaped protrusions 29 or two of the substantially strip-shaped depressions 30. Due to the manufacturing process, the structures are not completely identical to each other. The period is therefore subject to certain fluctuations along the surface. For example, the periodic structures can have a period in a spatial direction perpendicular to the surface (e.g. the spatial direction×running parallel to the x-axis 8) of less than 10 μm, optionally of at least 0.3 μm and/or at most 2 μm.

The periodic structures comprise alternately arranged substantially strip-shaped protrusions 29 and depressions 30, i.e. the periodic structures comprise substantially strip-shaped protrusions 29 and substantially strip-shaped depressions 30, wherein these protrusions 29 and depressions 30 are arranged alternately, i.e. the depressions 30 each extend between the or in each case two of the protrusions 29 and are bounded and/or formed by these. In addition, the substantially strip-shaped protrusions 29 and/or depressions 30 can also be partially branched, as can be seen in FIG. 7.

The substantially strip-shaped protrusions 29 have a width in the range from 250 nm to 700 nm, optionally from 350 nm to 600 nm, and the substantially strip-shaped depressions 30 have a width in the range from 100 nm to 550 nm, optionally from 200 nm to 450 nm. The width is typically measured at half height and perpendicular to the local longitudinal direction of the depressions 30 or the protrusions 39. The length is typically measured along the longitudinal direction (or the course) of the depressions 30 or the protrusions 29.

Furthermore, the substantially strip-shaped depressions 30 have a depth in the range of 0.05 to 0.7 μm. The depth of the substantially strip-shaped depressions 30 can, for example, be determined using SEM (scanning electron microscopy) or SEM images. The depth is usually measured perpendicular to the surface formed by the substantially strip-shaped protrusions. For example, the depth of the substantially strip-shaped depressions 30 can vary along the course of the individual depressions 30.

The nanostructures 31 are in the form of substantially dot-shaped protrusions. Furthermore, the nanostructures 31 or the substantially dot-shaped protrusions are arranged at least on the substantially strip-shaped protrusions 29. In addition, the nanostructures 31 can also be arranged in the form of substantially dot-shaped protrusions on that is, in the substantially strip-like depressions 30. However, it is possible that the nanostructures 31 are arranged in the form of substantially dot-shaped protrusions exclusively on the substantially strip-shaped protrusions 29. A respective circumferential edge of the substantially dot-shaped depressions can be substantially round, circular, substantially elliptical or substantially oval.

Optionally, the nanostructures 31 are arranged in the form of the substantially dot-shaped protrusions on the boundary surfaces of the substantially strip-shaped protrusions 29. Here, the boundary surface of the respective protrusion 29 represents the entire surface area of the respective protrusion 29 that lies above half the height of the protrusion 29, measured between the lowest point of an adjacent depression 30 and the highest point of the protrusion 29.

The nanostructures 31 have (in each case) an average diameter in the range from 10 nm to 200 nm, optionally from 30 nm to 150 nm, optionally from 50 nm to 120 nm, and (in each case) a maximum diameter in the range from 10 nm to 300 nm, optionally from 30 nm to 250 nm, optionally from 50 nm to 200 nm. For example, the nanostructures 31 may (in each case) have a minimum diameter in the range from 5 to 60 nm, optionally from 10 to 55 nm, optionally from 15 to 50 nm. Typically, the average diameter of the individual nanostructures 31 varies from nanostructure 31 to nanostructure 31 over a certain range, i.e. the nanostructures 31 vary in size.

Furthermore, the surface area of each nanostructure 31 is in the range from 80 nm² to 40,000 nm², optionally from 800 nm² to 20,000 nm², optionally from 2,000 nm² to 10,000 nm². The surface area of a nanostructure 31 can be understood as the size of the area that the nanostructure 31 covers or occupies in the top view of the surface on which it is located. Typically, the surface area of the individual nanostructures 31 varies from nanostructure 31 to nanostructure 31 over a certain range, i.e. the nanostructures 31 vary in size.

The surface structures of the first surface regions 27 can age over time. FIG. 6A shows an SEM image of such an aged surface structure, while FIG. 6B shows an enlarged view of a section of the SEM image from FIG. 6A. The aged surface structurings also have the periodic structures, which comprise the alternately arranged, substantially strip-shaped protrusions 29 and depressions 30, as well as the nanostructures 31 in the form of substantially dot-shaped protrusions, which are arranged (at least) on the substantially strip-shaped protrusions 29. However, as the surface structuring ages, the surface density of the nanostructures 31 increases, at least on the substantially strip-shaped protrusions 29. The areal density of the nanostructures is understood here to be the proportion of the area of the total area of the substantially strip-shaped protrusions 29 that the nanostructures 31 occupy or cover in the form of dot-shaped protrusions. With increasing areal density of the dot-shaped protrusions, the hydrophilic properties mute into hydrophobic properties and the surface structuring no longer serves as flow stopper for an apolar coating material.

FIG. 8A, FIG. 8B and FIG. 9 each show schematically a cross-section of a portion of a metallic layer in the form of a metallic plate 2c during the performance of an exemplary embodiment of the method according to the present disclosure for producing a component for an electrochemical system which can be used, for example, in an electrochemical system 1 of the type of system 1 of FIG. 1 and FIG. 2A or FIG. 2B. The metallic plate 2c can thus represent, for example, a separator plate that can be connected to another separator plate to obtain a bipolar plate or a separator plate 2d, 2e of an electrolytic cell that can be used individually. The metallic plate 2c can also already be connected to another separator plate at the time the process step is carried out. However, the metallic plate 2c can also represent a sealing frame 40, which can be arranged on or around a separator plate. FIG. 8A and FIG. 8B relate to two different exemplary embodiments of the method according to the present disclosure, which lead to two different exemplary embodiments of the component according to the present disclosure for an electrochemical system, wherein these differ from one another by the different position of the first and second surface regions 27 and 28. Finally, FIG. 9 shows an embodiment which differs from the embodiment shown in FIG. 8B only in that a different coating material was used, specifically a foamed coating material with inflated microspheres 33, and in that before or after the creation of the surface structuring on the two first surface areas, the second surface area was provided with a further surface structuring comprising a plurality of further depressions 32. In principle, however, the foamed coating material could also be used independently of the further depressions 32. However, the position of the first and second surface regions 27 and 28 is the same in the embodiments of FIG. 8B and FIG. 9.

In all three embodiments of FIG. 8A, FIG. 8B and FIG. 9, the metallic plate 2c comprises several sealing beads 12. In the sections shown in FIGS. 8A-B and 9, only one of the sealing beads 12 is shown as an example. The sealing beads 12 each have a bead roof 24 running along the main direction of extension of the respective sealing bead as well as a first and a second bead flank 25a and 25b each running adjacent to the bead roof 24 along the main direction of extension of the respective sealing bead. Respective bead feet 22a and 22b are laterally connected to the sealing bead 12.

In all three embodiments of FIG. 8A, FIG. 8B and FIG. 9, the sealing beads 12 have two first surface regions 27 and a second surface region 28 arranged between the two first surface regions 27 and directly adjacent to the two first surface regions 27. In addition, in all three embodiments of FIG. 8A, FIG. 8B and FIG. 9, the two first surface regions 27 and the second surface region 28 extend essentially parallel to a main direction of extension of the respective sealing bead 12 and optionally extend over the entire length or the entire course of the respective sealing bead 12. In all three cases, the two first surface regions 27 can each have a width in the range from 90 μm to 460 μm, optionally from 95 μm to 300 μm, optionally from 100 μm to 200 μm.

In each of the two embodiments of FIGS. 8A, 8B, a moment of the method is shown in which the at least one apolar liquid coating material comprising at least one component forming at least one elastomer has just been applied to the second surface region 28 such that a wet layer 26a of the liquid coating material is disposed on the second surface region 28. An elastomeric sealing element can be formed from this, for example, by at least partial cross-linking. In FIG. 9, on the other hand, the elastomer sealing element is already partially cross-linked and foamed.

Accordingly, in all three embodiments of FIG. 8A, FIG. 8B and FIG. 9, the two first surface areas 27 each have a special surface structuring which is produced by laser treatment. The surface structures of the first two surface regions 27 have periodic structures and nanostructures 31, wherein the periodic structures comprise alternately arranged substantially strip-shaped protrusions 29 and depressions 30 and wherein the nanostructures 31 are formed in the form of substantially dot-shaped protrusions and are arranged (at least) on the substantially strip-shaped protrusions 29.

In FIG. 8A, one of the two first surface regions 27 is arranged on an edge of the bead roof 24 that directly adjoins the first bead flank 25a and the other of the two first surface regions 27 is arranged on an edge of the bead roof 24 that directly adjoins the second bead flank 25b. The second surface region 28 extends almost (but not completely) across the entire width of the bead roof 24, so that the bead roof 24 is coated with the wet layer 26a almost (but not completely) across its entire width. Due to the surface structuring on the two first surface regions 27, the liquid coating material does not flow onto the bead flanks 25a and 25b, but stops at the two first surface regions 27. Accordingly, the elastomeric sealing element ultimately obtained is only arranged on the bead roof 24 and not on the bead flanks 25a and 25b. As a result, a very good sealing effect can be achieved with low material consumption.

In FIG. 8B, one of the two first surface regions 27 is arranged on an edge of the first bead flank 25a that directly adjoins the bead roof 24 and the other of the two first surface regions 27 is arranged on an edge of the second bead flank 25b that directly adjoins the bead roof 24. The second surface region 28 extends over the entire width of the bead roof 24, so that the bead roof 24 is coated with the wet layer 26a over its entire width. Due to the surface structuring on the two first surface regions 27, the liquid coating material does not flow onto the bead flanks 25a and 25b, but stops at the two first surface regions 27. Accordingly, the elastomeric sealing element ultimately obtained is only arranged on the bead roof 24 and not on the bead flanks 25a and 25b. As a result, a very good sealing effect can be achieved with low material consumption. In particular, the embodiment shown in FIG. 8B allows the maximum available width of the bead roof surface to be utilized and thus ensures the maximum possible sealing width of the elastomeric sealing element. Overall, a particularly good sealing effect can therefore be achieved.

In addition to the features described here, the metallic plate 2c of FIG. 8A or 8B can, for example, be configured like the separator plates 2a, 2b of the bipolar plate of the electrochemical system of FIG. 4A/B (or according to the relevant embodiments). In particular, this also applies to all information on surface structuring.

The embodiment shown in FIG. 9 differs from the embodiment shown in FIG. 8B only in that a different coating material was used and that before or after creating the surface structuring on the two first surface regions, the second surface region was provided with a further surface structuring, which has a plurality of further depressions 32.

Thus, firstly, in the embodiment according to FIG. 9, in contrast to the embodiment in FIG. 8B, the at least one apolar liquid coating material is at least one foamable material which additionally comprises expandable microspheres 33. The elastomeric sealing element can be formed here by expanding the microspheres 33. As a result, an elastomeric sealing element containing or consisting of a foamed material with microspheres 33 is formed.

In the expanded state shown, the microspheres 33 can have an average diameter of at least 20 μm and/or at most 150 μm. After the foamable material was applied, a solvent contained in the foamable material was vaporized.

The further surface structuring, which is located on the second surface region 28, differs from the surface structuring of the at least two first surface regions 27. Thus, the further surface structuring is not a surface structuring comprising periodic structures, which comprise alternately arranged substantially strip-shaped protrusions and depressions, as well as nanostructures in the form of substantially dot-shaped protrusions arranged at least on the substantially strip-shaped protrusions 29. In addition, the further depressions 32 differ from the substantially strip-shaped depressions 30 of the periodic structures.

FIG. 10 shows an optical microscope image of the further surface structuring, which can be used to characterize the further surface structuring more precisely.

Thus, the further depressions 32 of the further surface structuring have a diameter in the range from 50 μm to 80 μm, optionally from 60 μm to 70 μm, optionally of about 65 μm. In addition, the further depressions 32 have a depth of at least 2 μm and/or at most 40 μm and a depth of at most 20% of the thickness of the metallic layer. The diameter can be measured at half the height of the depressions 32 and/or parallel to the untreated surface of the metallic layer. The depth can be measured, for example, from the untreated surface of the metallic layer to the deepest point of the recess 32.

According to the image in FIG. 10, a peripheral edge of the further depressions 32 is substantially round or circular.

The size of the individual additional depressions is in the range of 0.0001 to 0.05 mm², optionally 0.0008 to 0.02 mm² and optionally 0.001 to 0.01 mm². In addition, there are around 500 to 100,000, optionally around 4,000 to 20,000, depressions per square centimeter.

By combining the further surface structuring on the second surface region 28 with the use of a foamable material with microspheres 33 as a coating material, the adhesion of the elastomeric sealing element to the metallic layer can be significantly improved.

In addition to the features described here, the metallic plate 2c of FIG. 9 can, for example, be configured like the separator plates 2a, 2b of the bipolar plate of the electrochemical system of FIG. 4A/B (or according to the relevant embodiments). In particular, this also applies to all information about surface structuring.

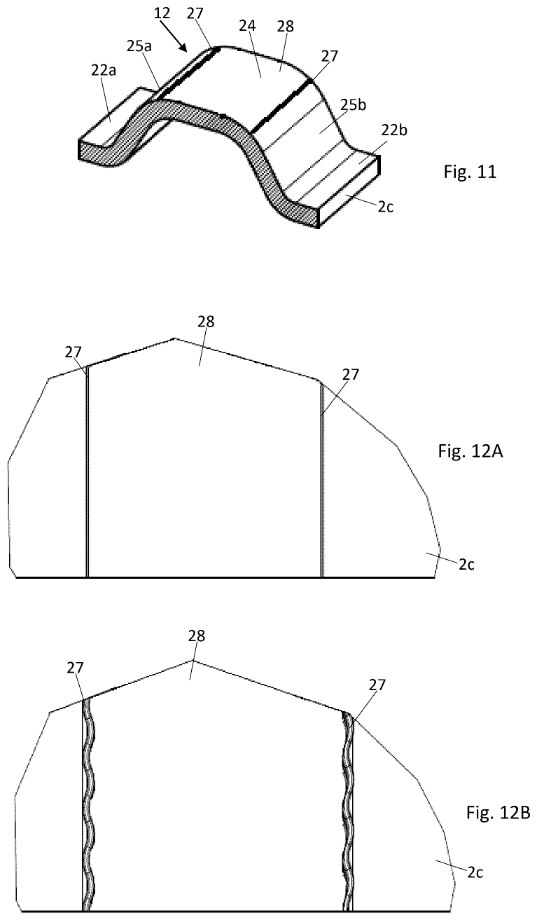

FIG. 11 schematically shows a section of a portion of a metallic layer in the form of a metallic plate 2c during the implementation of an exemplary embodiment of the method according to the present disclosure for producing a component for an electrochemical system which can be used, for example, in an electrochemical system 1 of the type of system 1 of FIG. 1. The metallic plate 2c can therefore be a separator plate, for example, which can be connected to another separator plate to form a bipolar plate.

In the section shown in FIG. 11, only one of the sealing beads 12 is shown as an example. The sealing bead 12 has a bead roof 24 running along the main direction of extension of the respective sealing bead as well as a first and a second bead flank 25a and 25b each running adjacent to the bead roof 24 along the main direction of extension of the sealing bead.

The sealing bead 12 has two first surface regions 27 and a second surface region 28 arranged between the two first surface regions 27 and directly adjacent to the two first surface regions 27. In addition, the two first surface regions 27 and the second surface region 28 run essentially parallel to a main direction of extension of the sealing bead 12 and may extend over the entire length or the entire course of the sealing bead 12. The two first surface regions 27 can each have a width in the range from 90 μm to 460 μm, optionally from 95 μm to 300 μm, optionally from 100 μm to 200 μm.

In FIG. 11, a moment of the method is shown after the laser treatment of the two first surface regions 27 of the sealing bead 12 but before the second surface region 28 of the sealing bead 12 is provided with at least one elastomeric sealing element.

Accordingly, in the embodiment shown in FIG. 11, the two first surface regions 27 of the sealing beads 12 each have a special surface structuring which is produced by laser treatment. The surface structures of the two first surface regions 27 have periodic structures and nanostructures 31, wherein the periodic structures comprise alternately arranged substantially strip-shaped protrusions 29 and depressions 30 and wherein the nanostructures 31 are formed in the form of substantially dot-shaped protrusions and are arranged (at least) on the substantially strip-shaped protrusions 29 (see FIGS. 5A to 7).

If, in the next process step, the second surface region 28 of the sealing bead is now provided with at least one elastomeric sealing element, that is, at least one apolar liquid coating material comprising at least one component forming at least one elastomer is applied to the second surface region, the liquid coating material does not flow onto the bead flanks 25a and 25b due to the surface structuring on the two first surface regions 27, but stops at the boundary of the two first surface regions 27. Accordingly, the elastomeric sealing element ultimately obtained is only arranged on the bead roof 24 and not on the bead flanks 25a and 25b. As a result, a very good sealing effect can be achieved with low material consumption.

In addition to the features described here, the metallic plate 2c of FIG. 11 can, for example, be configured like the separator plates 2a, 2b of the bipolar plate of the electrochemical system of FIG. 4A/B, that is, according to the relevant embodiments in this respect. In particular, this also applies to all information about surface structuring.

FIG. 12A and FIG. 12B each show a top view of a section of a metallic layer in the form of a metallic plate 2c, as shown in FIG. 11. The statements made there therefore also apply here. In the exemplary embodiment in FIG. 12A, the two first surface regions 27 each have a linear course. In the exemplary embodiment in FIG. 12B, the two first surface regions 27 have a wavy shape.

The flow chart in FIG. 13 summarizes the method according to the present disclosure for manufacturing a component for an electrochemical system. In the first step B, at least one metallic layer with at least one sealing bead formed therein is provided. This can be done, for example, by forming webs and channels into a plate, such as a stainless-steel plate of alloy 1.4404 with a sheet thickness of 0.075 mm. Then, in process step L, at least two first surface regions of the at least one sealing bead are subjected to at least one laser treatment. The at least two first surface areas are irradiated with laser pulses using a pulsed laser. The first surface regions of the webs can, for example, be subjected to laser treatment with a laser with a wavelength of 1064 nm and a pulse duration of <15 ps at a frequency of 50 kHz and a total fluence of 80 J/cm² or a fluence per pulse of 0.577 J/cm². This produces surface structurings on the at least two first surface regions, which have periodic structures comprising, on the one hand, alternately arranged, substantially strip-shaped protrusions and depressions, and, on the other hand, nanostructures in the form of substantially dot-shaped protrusions, which are arranged at least on the substantially strip-shaped protrusions. Subsequently, optionally without delay, optionally after less than 12 h, in process step C at least one second surface region of the at least one sealing bead, which is arranged between the at least two first surface regions and directly adjoins the at least two first surface regions, is provided with at least one elastomeric sealing element. At least one apolar liquid coating material containing at least one component forming at least one elastomer, as known from the prior art, is applied to the at least one second surface region.

### LIST OF REFERENCE SIGNS

1 electrochemical system
2 bipolar plate
2a separator plate
2b separator plate
2c metallic plate
2d, 2e Separator plates
3 end plate
4 end plate
5 media port
7 z-direction
8 x-direction
9 y-direction
10 membrane electrode assembly (MEA)
11a through-opening
11b through-opening
11c through-opening
12 sealing bead
12a sealing bead
12b sealing bead
12c sealing bead
12d sealing bead
12e sealing bead
12e′ Sealing bead of the through-opening 48
12f sealing bead
12g sealing bead
13a passage
13b passage
13c passage
15 edge region
17 Flow field
18 active region
19 cavity
20 distribution or collection region
22a First bead foot
22b Second bead foot
23 contact area
24 bead roof
25a first bead flank
25b Second bead flank
26 elastomeric sealing element
26a Wet layer
27 First surface region
28 Second surface region
29 Substantially strip-shaped protrusion
30 Substantially strip-shaped depression
31 Nanostructure
32 further depression
33 Microsphere
40 Sealing frame
41 media diffusion structure
42 cell frame
43 media diffusion structure
44 cell frame
45 membrane electrode assembly
46 through-opening
47 through-opening
48 through-opening
49 Single cell of an electrolyzer
50 positioning holes
51 flow field

1. A method of manufacturing a component for an electrochemical system, in which
a) at least one metallic layer with at least one sealing bead formed therein is provided,
b) each of at least two first surface regions of the at least one sealing bead are subjected to at least one laser treatment, in which the at least two first surface regions are irradiated by means of a pulsed laser with laser pulses which have a pulse duration of less than 1 ns, wherein surface structurings are produced on the at least two first surface regions by the at least one laser treatment, which surface structurings comprise periodic structures that comprise alternately arranged substantially strip-shaped protrusions and substantially strip-shaped depressions, as well as nanostructures in the form of substantially dot-shaped protrusions that are arranged at least on the substantially strip-shaped protrusions, and
c) each of at least one second surface region of the at least one sealing bead, which is arranged between the at least two first surface regions and directly adjoins the at least two first surface regions, is provided with at least one elastomeric sealing element, wherein at least one apolar liquid coating material comprising at least one component forming at least one elastomer is applied to the at least one second surface region.

2. The method according to claim 1, wherein
the pulse duration of the laser pulses is less than 100 ps, and/or
a fluence introduced into the at least two first surface regions by irradiation with the laser pulses is in a range from 15 J/cm² to 120 J/cm².

3. The method according to claim 1, wherein step c) is carried out at the latest 72 h after step b).

4. The method according to claim 1, wherein
the substantially strip-shaped protrusions have a width in the range from 250 nm to 700 nm, and/or the substantially strip-shaped depressions have a width in the range from 100 nm to 550 nm, and/or
the nanostructures have an average diameter in the range from 10 nm to 200 nm, and/or
the nanostructures have a maximum diameter in the range from 10 nm to 300 nm, and/or
the nanostructures each have a surface area in the range from 80 nm² to 40,000 nm², and/or
an areal density of the nanostructures on the substantially strip-shaped protrusions is in the range from 1 to 10%.

5. The method according to claim 1, wherein the at least one metallic layer is formed from stainless steel and/or at least one titanium alloy.

6. The method according to claim 1, wherein
the providing the at least one second surface region with the at least one elastomeric sealing element comprises using a method selected from the group consisting of screen printing method, roller printing method, stencil printing method, dispensing method, and combinations thereof, and/or
the at least one elastomer is selected from the group consisting of fluoro rubbers, silicone rubbers, nitrile-butadiene rubbers, polyurethanes, natural rubbers, perfluoro rubbers, styrene-butadiene rubbers, butyl rubbers, fluorosilicone rubbers, chlorosulfonated polyethylene, silicone resins, epoxy resins, hydrogenated nitrile-butadiene rubbers, ethylene-propylene-diene rubbers, olefin-based resins, polyisobutylenes, ethyl-2-cyanoacrylate, and mixtures thereof.

7. The method according to claim 1, wherein the at least one apolar liquid coating material is at least one foamable material that additionally comprises expandable microspheres, wherein, after application of the at least one apolar liquid coating material to the at least one second surface region, the at least one elastomeric sealing element is formed by expansion of the microspheres, wherein the microspheres
have an average diameter of at least 5 μm and/or at most 50 μm in an unexpanded state, and/or
have an average diameter of at least 20 μm and/or at most 150 μm in an expanded state.

8. The method according to claim 1, wherein
the at least two first surface regions and/or the at least one second surface region extend substantially parallel to a main direction of extension of the respective sealing bead and/or extend over the entire length of the respective sealing bead, and/or
the at least two first surface regions each have a width in the range from 90 μm to 460 μm.

9. The method according to claim 1, wherein the at least one sealing bead has a respective bead roof, and a respective first bead flank and a respective second bead flank adjoining the bead roof, wherein
at least one of the at least two first surface regions is arranged on an edge of the first bead flank that directly adjoins the bead roof and/or on the bead roof, and
at least one further first surface region of the at least two first surface regions is arranged on an edge of the second bead flank that directly adjoins the bead roof and/or on the bead roof, and/or
the at least one second surface region is arranged on the bead roof,
the at least one second surface region is arranged exclusively on the bead roof, and/or
the at least one second surface region extends over the entire width of the bead roof or in sections over the width of the bead roof.

10. The method according to claim 1, wherein the at least one second surface region is provided with a further surface structuring before step c), wherein the further surface structuring comprises a plurality of further depressions, wherein the further depressions
have a width and/or a diameter in the range from 10 μm to 150 μm, and/or
have a depth of at least 2 μm and/or at most 40 μm and/or have a depth of at most 20% of a thickness of the metallic layer, and/or
can be produced by laser radiation, or by microstructuring embossing.

11. The method according to claim 1, wherein the component for the electrochemical system is a bipolar plate for the electrochemical system, a separator plate for the electrochemical system or a sealing frame for the electrochemical system.

12. A component for an electrochemical system, comprising at least one metallic layer with at least one sealing bead formed therein, each sealing bead having at least two first surface regions and at least one second surface region arranged between the at least two first surface regions and directly adjoining the at least two first surface regions, the at least two first surface regions having surface structurings comprising periodic structures that comprise alternately arranged substantially strip-shaped protrusions and substantially strip-shaped depressions, as well as nanostructures in the form of substantially dot-shaped protrusions which are arranged at least on the substantially strip-shaped protrusions, and wherein the at least one second surface region is provided with at least one elastomeric sealing element.

13. The component according to claim 12, wherein
the substantially strip-shaped protrusions have a width in the range from 250 nm to 700 nm, and/or the substantially strip-shaped depressions have a width in the range from 100 nm to 550 nm, and/or
the nanostructures have an average diameter in the range from 10 nm to 200 nm, and/or
the nanostructures have a maximum diameter in the range from 10 nm to 300 nm, and/or
the nanostructures each have a surface area in the range from 80 nm² to 40,000 nm², and/or
an areal density of the nanostructures on the substantially strip-shaped protrusions is in the range from 1 to 10%.

14. The component according to claim 12, wherein the at least one metallic layer is formed from stainless steel and/or at least one titanium alloy.

15. The component according to claim 12, wherein the at least one elastomeric sealing element
contains at least one elastomer selected from the group consisting of fluoro rubbers, silicone rubbers, nitrile-butadiene rubbers, polyurethanes, natural rubbers, perfluoro rubbers, styrene-butadiene rubbers, butyl rubbers, fluorosilicone rubbers, chlorosulfonated polyethylene, silicone resins, epoxy resins, hydrogenated nitrile-butadiene rubbers, ethylene-propylene-diene rubbers, olefin-based resins, polyisobutylenes, ethyl-2-cyanoacrylate, as well as mixtures thereof, and/or
contains or consists of at least one foamed material with microspheres, wherein an average diameter of the microspheres is at least 20 μm and/or at most 150 μm.

16. The component according to claim 12, wherein
the at least two first surface regions and/or the at least one second surface region extend substantially parallel to a main direction of extension of the respective sealing bead and/or extend over the entire length of the respective sealing bead, and/or
the at least two first surface regions each have a width in the range from 90 μm to 460 μm.

17. The component according to claim 12, wherein the at least one sealing bead has a respective bead roof, and a respective first bead flank and a respective second bead flank adjoining the bead roof, wherein
at least one of the at least two first surface regions is arranged on an edge of the first bead flank that directly adjoins the bead roof and/or on the bead roof, and
at least one further of the at least two first surface regions is arranged on an edge of the second bead flank that directly adjoins the bead roof and/or on the bead roof, and/or
the at least one second surface region is arranged on the bead roof, and/or
the at least one second surface region is arranged exclusively on the bead roof, and/or
the at least one second surface region extends over the entire width of the bead roof (24) or extends partially over the width of the bead roof.

18. The component according to claim 12, wherein the at least one second surface region under the at least one elastomeric sealing element has a further surface structuring with a plurality of further depressions, wherein the further depressions
have a width and/or a diameter in the range from 10 μm to 150 μm, and/or
have a depth of at least 2 μm and/or at most 40 μm and/or have a depth of at most 20% of a thickness of the metallic layer, and/or
have been produced by laser radiation, or by microstructuring embossing.

19. The component according to claim 12, wherein the component is a bipolar plate for the electrochemical system, a separator plate for the electrochemical system or a sealing frame for the electrochemical system.

20. An electrochemical system comprising at least one component according to claim 12.
